(19) United States
(12) Patent Application Publication
(10) Pub. No.: US 2011/0025854 A1
(43) Pub. Date: Feb. 3, 2011

(54) CONTROL DEVICE, OPERATION SETTING METHOD, AND PROGRAM

(75) Inventor: Shingo YOSHIZUMI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/814,877

(22) Filed: Jun. 14, 2010

(30) Foreign Application Priority Data
Jul. 29, 2009 (JP) 2009-176577

(51) Int. Cl. H04N 5/225

(52) U.S. Cl. 348/169; 348/E05.048

(57) ABSTRACT

A control device includes an operation decision unit which inputs the information on image data and a subject detected in an image of the image data and decides the operations to be executed based on the position of the subject in the image in the case of a predetermined limitation position state.

### BACKGROUND OF THE INVENTION

1. Field of the Invention

The present invention relates to a control device for executing necessary operations based on the content of images which can be obtained, for example, by imaging, and to an operation setting method thereof. In addition, the present invention also relates to a program for causing such a control device to execute necessary processes.

2. Description of the Related Art

The applicant of the present invention proposed a configuration for automatic imaging and recording operations disclosed in Japanese Unexamined Patent Application Publication No. 2009-100300. That is, the applicant proposed a technique for detecting a subject appearing in the image of the captured image data which can be obtained using an imaging device, and for imaging and recording this detected subject.

### SUMMARY OF THE INVENTION

It is preferable to provide functions which are useful for the users and to allow the above-mentioned automatic imaging and recording operations to function with more varieties.

According to an embodiment of the present invention, there is provided a control device with the following configuration.

That is, the control device includes an operation decision unit which inputs the information on image data and a subject detected in an image of the image data and decides the operations to be executed based on the position of the subject in the image in the case of a predetermined limitation position state.

With the above configuration, necessary operations with regard to the image data are decided based on the subject position in the image of the image data, which can be obtained correspondingly to a predetermined limitation position state.

With this configuration according to the embodiment of the present invention, it is possible to cause the control device to automatically execute appropriate operations which corresponds with the content of the images. If this configuration is applied to automatic imaging and recording operations of an imaging system, for example, it is possible to allow these automatic imaging and recording operations to function with more varieties.

### BRIEF DESCRIPTION OF THE DRAWINGS

FIGS. 1A and 1B are front and back views simply illustrating an appearance of a digital still camera which is an imaging device constituting an imaging system according to an embodiment of the invention;

FIG. 2 is a perspective view illustrating an appearance example of a platform constituting the imaging system according to an embodiment of the invention;

FIG. 3 is a front view illustrating an example of a state in which the digital still camera is attached to the platform as the imaging system according to an embodiment of the invention;

FIG. 4 is a top plan view illustrating an example of a state in which the digital still camera is attached to the platform as the imaging system according to an embodiment of the invention along with an example of a moving behavior in a pan direction;

FIGS. 5A and 5B are side views illustrating an example of a state in which the digital still camera is attached to the platform as the imaging system according to an embodiment of the invention;

FIG. 6 is a block diagram illustrating a configuration example of the digital still camera;

FIG. 7 is a block diagram illustrating a configuration example of the platform;

FIG. 8 is a diagram illustrating a configuration of block units of functions, which are provided in the digital still camera according to an embodiment of the invention for the composition control.

FIG. 9 is a flow chart illustrating a basic algorithm for the automatic imaging and recording operations according to an embodiment of the invention.

FIGS. 10A and 10B are diagrams respectively illustrating a determined composition and an example of image content which can be actually obtained by a restriction of the tilt angle, while comparing the both.

FIG. 11 is a diagram illustrating an example of a positional relationship between the digital still camera and a subject, which corresponds with the image content shown in FIG. 10B.

FIG. 12 is a flow chart illustrating an example of an algorithm for automatic imaging and recording operations according to a first embodiment of the invention.

FIG. 13 is a flow chart illustrating an example of an algorithm for automatic imaging and recording operations according to a second embodiment of the invention.

FIG. 14 is a flow chart illustrating an example of an algorithm for automatic imaging and recording operations according to a third embodiment of the invention.

FIGS. 15A and 15B are diagrams illustrating a positional relationship between the digital still camera and the subject when the determined composition is not obtained at a limitation position in the pan direction.

FIG. 16 is a diagram illustrating an example of an image content of a captured image data which is obtained in accordance with the positional relationship between the digital still camera and the subject shown in FIG. 15.

FIG. 17 is a flow chart illustrating an example of an algorithm for automatic imaging and recording operations according to a fourth embodiment of the invention.

FIG. 18 is a diagram illustrating an example of a method for detecting an absolute position information of the subject.

FIG. 19 is a diagram illustrating a configuration example as a modified example of an imaging system according to an embodiment of the invention.

FIG. 20 is a diagram illustrating a configuration example as another modified example of an imaging system according to an embodiment of the invention.

FIG. 21 is a diagram illustrating a configuration example of an editing device as an application example according to an embodiment of the invention.

FIG. 22 is a diagram illustrating an example of trimming processing for the image data by the editing device shown in FIG. 21.

### DESCRIPTION OF THE PREFERRED EMBODIMENTS

Hereinafter, the description will be made of the embodiments for implementing the present invention in the following order:

### <1. Configuration of Imaging System>

### [1-1. Overall Configuration]

### [1-2. Digital Still Camera]

### [1-3. Platform]

<2. Functional Configuration Example Corresponding with Composition Control According to Embodiments>

### <3. Basic Algorithm Example of Automatic Imaging and Recording Operations>

### <4. First Embodiment>

### <5. Second Embodiment>

### <6. Third Embodiment>

### <7. Fourth Embodiment>

### <8. Modified Example of Imaging System According to Embodiments>

<9. Application of Embodiments: Trimming processing>

In this specification, the terms of “image frame”, “image angle”, “field-of-view range” and “composition” will be used in the following description.

The image frame is a range of an area corresponding to one screen into which an image looks like being fitted, for example, and usually has an oblong outer shape with longer vertical sides or with longer horizontal sides.

The image angle is also referred to as a zoom angle, and represents the range within the image frame, which depends on the position of the zoom lens in the optical system of the imaging device, as an angle. Generally, the image angle is considered to be dependent on a focal length of the imaging optical system and a size of the image plane (an image sensor or a film). However, the term “image angle” here is used to represent the components which are variable in accordance with the focal length.

The field-of-view range is a range within the image frame of the image which can be imaged and obtained by the imaging device located in a fixed position, the range depending on a pivotable angle in the pan (horizontal) direction and angles (an elevation angle and a depression angle) in the tilt (vertical) direction in addition to the above-mentioned image angle.

The term “composition” is also referred to as a “framing” here, and means an arrangement state of the subject in the image frame, which is determined depending on the field-of-view range, including the size setting.

The embodiments will be described while exemplifying the case in which the configuration based on the embodiments of the present invention is applied to the imaging system constituted by a digital still camera and a platform to which the digital still camera attaches.

### 1. Configuration of Imaging System

### 1-1. Overall Configuration

The imaging system according to the embodiments of the invention includes a digital still camera 1 and a platform 10 to which the digital still camera 1 attaches.

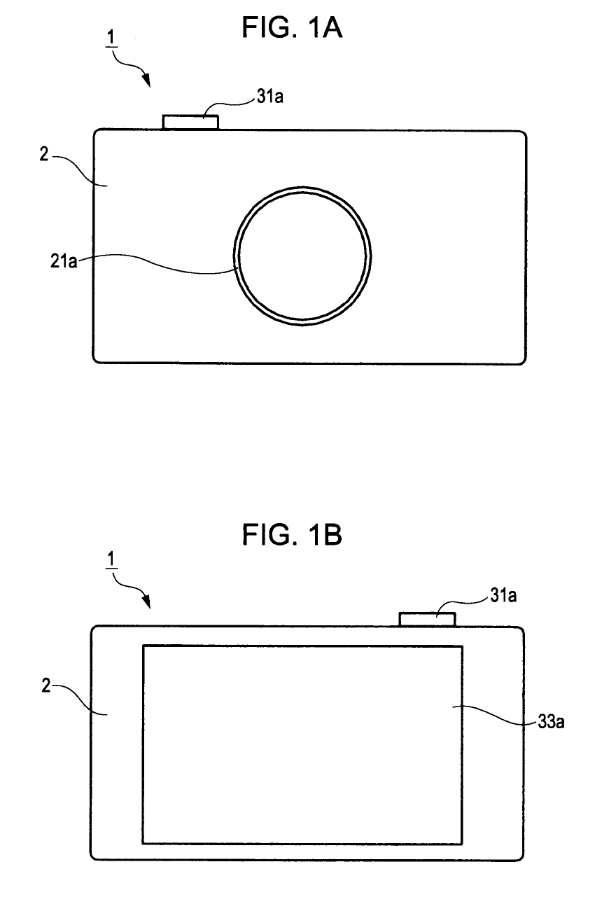

First, FIGS. 1A and 1B show an example of an appearance of the digital still camera 1. FIGS. 1A and 1B are a front view and a back view of the digital still camera 1, respectively.

The digital still camera 1 shown in the same drawings includes a lens unit 21a on the front face side of a main body part 2 as shown in FIG. 1A. This lens unit 21a is a portion which appears outside the main body part 2 as an optical system for imaging.

In addition, the upper face portion of the main body part 2 is provided with a release button 31a. In an imaging mode, the image (captured image) which is captured by the lens unit 21a is generated as an image signal. Then, when the release button 31a is operated in this imaging mode, the captured image obtained at this operating time is recorded in the storing medium as image data of a still image. That is, a picture is imaged.

Moreover, the digital still camera 1 includes a display screen unit 33a on the back face thereof as shown in FIG. 1B.

In the imaging mode, the image being currently captured by the lens unit 21a, which is referred to as a through-the-lens image, is displayed on the display screen unit 33a. In a replaying mode, the image data recorded in the storing medium is replayed and displayed. In addition, an operation image as a GUI (Graphical User Interface) is displayed in response to the user's operation on the digital still camera 1.

In addition, a touch panel is combined with the display screen unit 33a in the digital still camera 1 according to the embodiments of the invention. With this configuration, the user can perform necessary operations by placing its finger on the display screen unit 33a.

The imaging system (the imaging device) according to the embodiments of the invention includes the imaging unit as a digital still camera 1 and a movable mechanism unit (movable apparatus unit) as a platform 10, which will be described later. However, the user can perform the picture imaging in the same manner as in a general digital still camera when the user uses only the digital still camera 1.

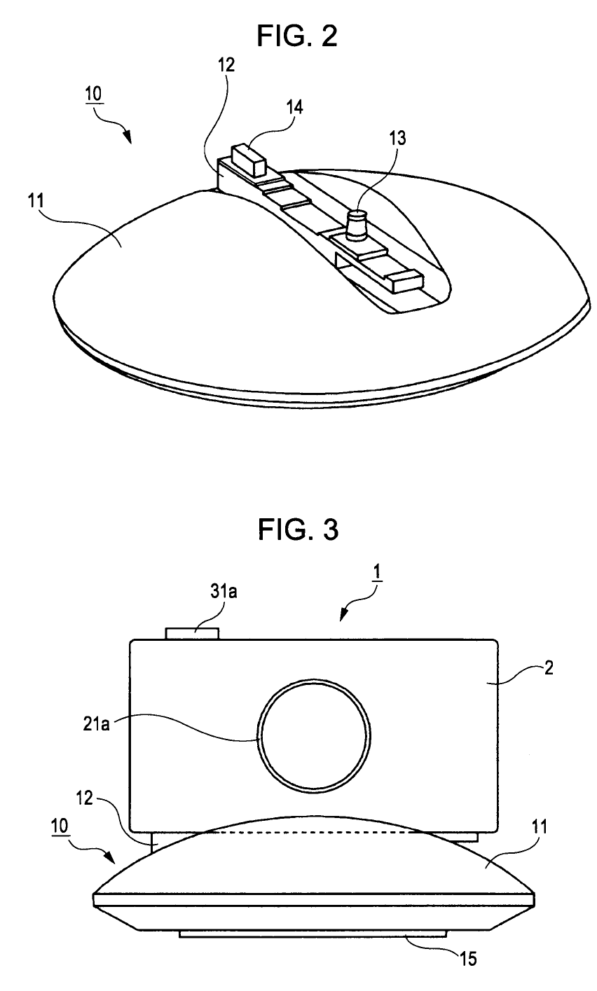

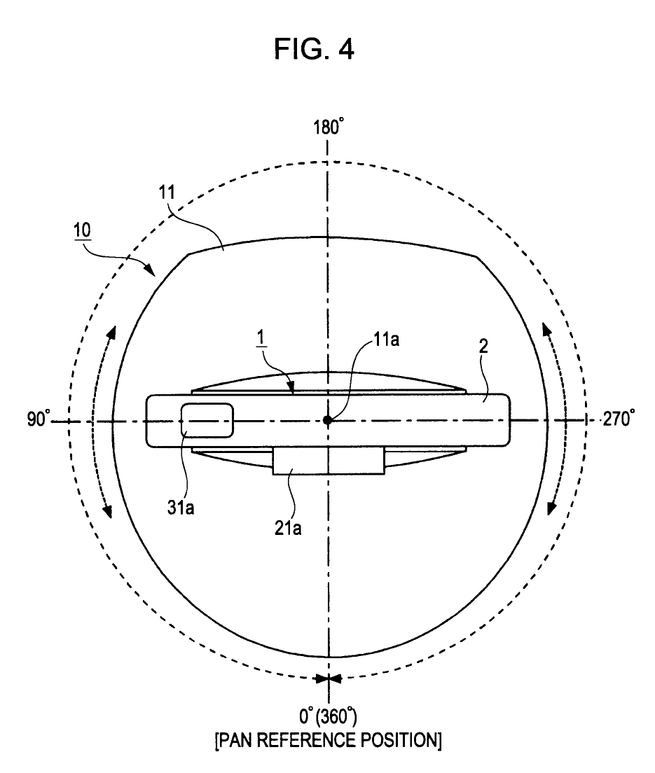

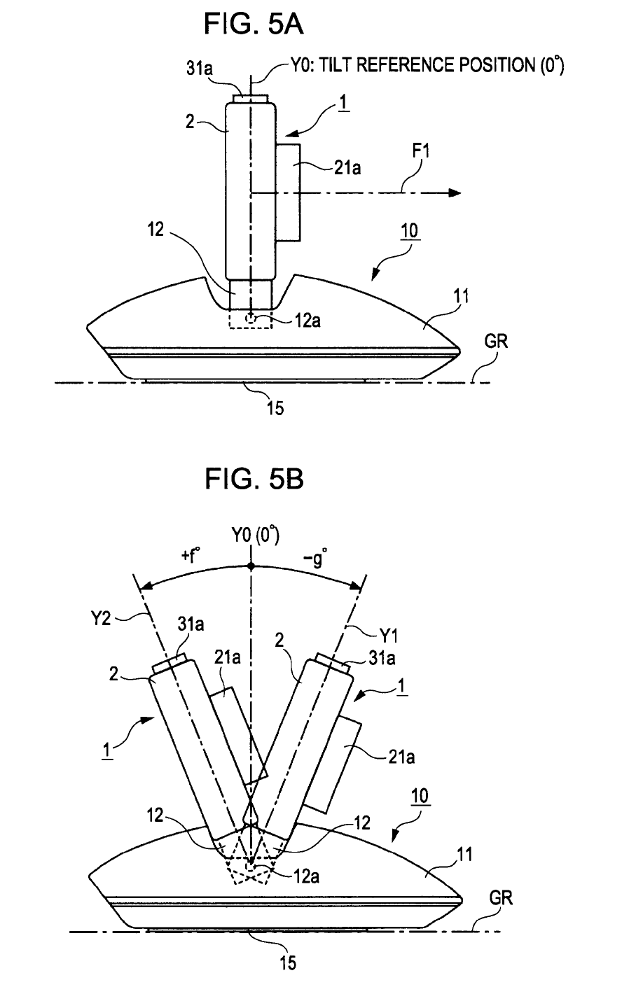

FIG. 2 is a perspective view illustrating the appearance of the platform 10. In addition, FIGS. 3 to 5B show the states in which the digital still camera 1 is appropriately attached to the platform 10 as the appearance of the imaging system according to the embodiments of the invention. FIG. 3 is a front view, FIG. 4 is a top plan view, FIG. 5A is a side view, and FIG. 5B is a side view illustrating a movable range of the tilt mechanism.

As shown in FIGS. 2, 3, 4, and 5A, the platform 10 has roughly a construction in which a main body part 11 is combined on a grounding base part 15 and a camera base part 12 is attached to the main body part 11.

When the digital still camera 1 is to be attached to the platform 10, the bottom face of the digital still camera 1 is placed on the upper face side of the camera base part 12.

The upper face part of the camera base part 12 in this case is provided with a protruding portion 13 and a connector 14 as shown in FIG. 2.

Although not shown in the drawings, the lower face part of the main body part 2 of the digital still camera 1 is provided with a hole portion which engages with the protruding portion 13. In the state in which the digital still camera 1 is appropriately placed on the camera base part 12, this hole portion and the protruding portion 13 engage with each other. In this state, the digital still camera 1 is configured not to be incorrectly-positioned or unattached from the platform 10 even when the platform 10 performs a panning or tilting operation in an ordinary manner.

Moreover, a predetermined position in the lower face portion of the digital camera 1 is provided with a connector. In the state in which the digital still camera 1 is appropriately mounted on the camera base part 12 as described above, the connector of the digital still camera 1 and the connector 14 of the platform 10 are connected with each other, and turn into a state in which at least both of them can communicate with each other.

In this regard, the connector 14 and the protruding portion 13 in practice are configured to be movable in the camera base part 12, for example. In addition, if an adapter which fits to the shape of a bottom face portion of the digital still camera 1 is used together with this platform 10, for example, a different type of digital still camera can be mounted on the camera base part 12 in a state in which the digital still camera can communicate with the platform 10.

In addition, the digital still camera 1 and the camera base part 12 may be configured to wirelessly communicate with each other.

In a state in which the digital still camera 1 is mounted on the platform 10, a configuration is also applicable in which the digital still camera 1 is charged from the platform 10. In addition, another configuration is also applicable in which movie signals such as images being replayed in the digital still camera 1 are transferred to the side of the platform 10 and then output from the platform 10 to the outside monitoring device through a cable or a wireless communication. That is, it is possible to provide the platform 10 with functions as a cradle without using it only for changing the field-of-view range of the digital still camera 1.

Next, the description will be made of the basic movement of the digital still camera 1 by the platform 10 in the pan and tilt directions.

First, the basic movement in the pan direction is as follows:

In a state in which this platform 10 is placed on the floor surface or the like, the bottom face of the grounding base part 15 is grounded. In this state, the main body part 11 is configured to be pivotable about a rotation axis 11a as a rotation center in a clockwise direction and a counterclockwise direction as shown in FIG. 4. With this configuration, the field-of-view range of the digital still camera 1 mounted on the platform 10 varies along the right and left direction (the horizontal direction). That is, the panning movement is added to the field-of-view range of the digital still camera 1.

In addition to this configuration, the pan mechanism of the platform 10 in this case is configured to be freely pivotable by 360° or more with no limitation in any of the clockwise and counterclockwise directions.

Moreover, in this pan mechanism of the platform, a reference position in the pan direction is set in advance.

Here, the pan reference position is set to 0° (360°) as shown in FIG. 4, and the rotation position of the main body part 11 along the pan direction, that is, the pan position is represented as an angle from 0° to 360°.

In addition, the basic movement of the platform 10 in the tilt direction is as follows:

The movement in the tilt direction can be obtained by configuring the camera base part 12 to be movable in both directions of the elevation angle and the depression angle about the rotation axis 12a as a rotation center as shown in FIGS. 5A and 5B.

Here, FIG. 5A shows a state in which the camera base part 12 is in a tilt reference position Y0 (0°). In this state, an imaging direction F1 which coincides with the imaging optical axis of the lens unit 21a (an optical system unit) and a grounding face part GR which is a grounding part of the ground base part 13 are parallel with each other.

In addition to the above configuration, the camera base part 12 can move in the elevation angle direction about the rotation axis 12a as a rotation center within the range from the tilt reference position Y0 (0°) to a predetermined maximum rotation angle +f° as shown in FIG. 5B. Moreover, the camera base part 12 can move in the depression angle direction about the rotation axis 12a as a rotation center within the range from the tilt reference position Y0 (0°) to the predetermined maximum rotation angle −g°. Since the camera base part 12 can move within the range from the maximum rotation angle +f° to the maximum rotation angle −g° while using the tilt reference position Y0 (0°) as a reference point, the field-of-view range of the digital still camera 1 mounted on the platform 10 (the camera base part 12) varies along the upper and lower direction (the vertical direction). That is, it is possible to obtain the tilting movement.

In this regard, the outer configuration of the platform 10 shown in FIGS. 2 to 5B is just an example. Other physical configurations and constructions may be applicable as long as the mounted digital still camera 1 can be moved in the pan direction and the tilt direction.

### [1-2. Digital Still Camera]

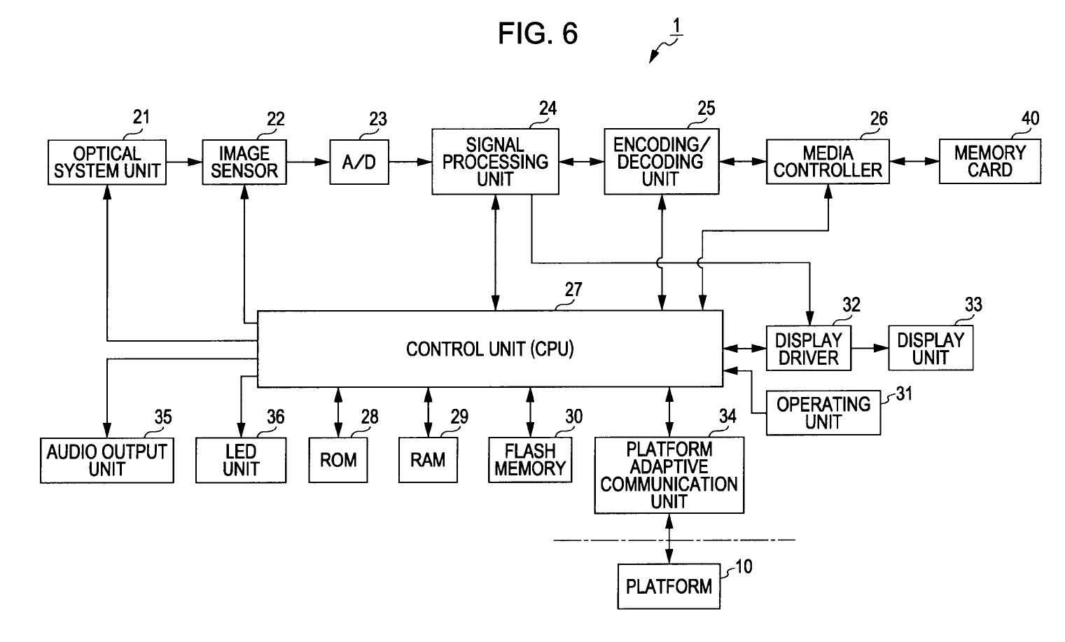

First, FIG. 6 is a block diagram illustrating the actual internal configuration example of the digital still camera 1.

In this drawing, the optical system unit 21 includes, for example, a diaphragm and the imaging lens group constituted by a predetermined number of lenses including a zooming lens, a focus lens, and the like. The optical system unit 21 causes an image sensor 22 to form the image on its light receiving surface using the incident light as the imaging light.

In addition, the optical system unit 21 is provided with a drive mechanism unit for driving the zoom lens, the focus lens, the diaphragm, and the like which are described above. The operations of the drive mechanism unit are controlled by a so-called camera control such as a zoom (image angle) control, an automatic focal point adjustment control, and an automatic exposure control which are executed by a control unit 27, for example.

The image sensor 22 performs a so-called photoelectric conversion which is an operation of converting the imaging light obtained at the optical system unit 21 to an electric signal. For this reason, the image sensor 22 receives the imaging light from the optical system unit 21 on the light receiving surface of the photoelectric conversion element, and sequentially outputs the signal charge charged in accordance with the light intensity of the received light, at predetermined timings. As a result, the electric signal corresponding to the imaging light (the imaging signal) is output. In addition, the photoelectric conversion element (the imaging element) employed as the image sensor 22 is not particularly limited. However, a CMOS sensor and a CCD (Charge Coupled Device) can be exemplified in the current condition. Moreover, when the CMOS sensor is employed, it is possible to employ a configuration including an analog-to-digital converter corresponding to an A/D converter 23, which will be described next, as a device (part) corresponding to the image sensor 22.

The imaging signal output from the image sensor 22 is input to the A/D converter 23, converted to a digital signal, and then input to the signal processing unit 24.

The signal processing unit 24 imports the digital imaging signal of a unit corresponding to, for example, one still image (a frame image), the digital imaging signal being output from the A/D converter 23. Then, the imaging signal of the unit of one still image which is imported in this manner is subjected to a necessary signal processing, and thereby the signal processing unit 24 can generate captured image data (captured still image data) which is image signal data corresponding to one still image.

When the captured image data generated by the signal processing unit 24 as described above is recorded as the image information in a memory card 40 which is a storing medium (a storing medium device), the captured image data corresponding to one still image is output from the signal processing unit 24 to an encoding/decoding unit 25, for example.

The encoding/decoding unit 25 executes a compression encoding on the captured image data of a unit of a still image data, which is output from the signal processing unit 24, by a predetermined method for the compression encoding of the still image. Then, the encoding/decoding unit 25 adds a header in accordance with the control by the control unit 27, for example, and converts the captured image data to image data which is compressed to a predetermined form. Thereafter, the image data generated in this manner is transferred to a media controller 26. The media controller 26 follows the control by the control unit 27, writes the transferred image data on the memory card 40, and causes the memory card 40 to record the image data. The memory card 40 in this case is a storing medium having a card shaped outer shape following a predetermined standard, and including therein a nonvolatile semiconductor memory element such as a flash memory. In addition, a different type or form of the storing medium in addition to the memory card may be also used as the storing medium for storing the image data.

Moreover, the signal processing unit 24 according to the embodiments of the invention is configured to execute an image processing as the subject detection while using the captured image data obtained as described above which will be described later.

In addition, the digital still camera 1 can cause the display unit 33 to execute an image display using the captured image data which can be obtained by the signal processing unit 24 and display a so-called through-the-lens image which is an image being currently captured. For example, the signal processing unit 24 imports the imaging signal output from the A/D converter 23 in the above-mentioned manner, and generates the captured image data corresponding to one still image. By continuously performing this operation, the signal processing unit 24 sequentially generates the captured image data corresponding to a frame image in a video image. Then, the signal processing unit 24 transfers the captured image data, which was sequentially generated in this manner, to the display driver 32 in response to the control of the control unit 27. As a result, the through-the-lens image is displayed.

The display driver 32 generates a drive signal for driving the display unit 33 based on the captured image data input from the signal processing unit 24 as described above, and outputs the drive signal to the display unit 33. Thereafter, the display unit 33 sequentially displays the image on the basis of the captured image data of a unit of a still image data. The user can view the images, which are considered to be captured at the time, like a video image on the display unit 33. That is, the through-the-lens image is displayed.

In addition, the digital still camera 1 can replay the image data recorded in the memory card 40 and cause the display unit 33 to display the image.

In order to do this, the control unit 27 designates the image data, and orders the media controller 26 to read the data from the memory card 40. According to the aforementioned order, the media controller 26 accesses an address on the memory card 40 in which the designated image data is recorded, reads the data, and then transfers the read data to the encoding/decoding unit 25.

The encoding/decoding unit 25 picks up substantial data as a compressed still image data from the captured image data which was transferred from the media controller 26 in accordance with the control of control unit 27 for example, executes a decoding processing on the compression-encoded still image data, and obtains the captured image data corresponding to one still image. Then, the encoding/decoding unit 25 transfers this captured image data to the display driver 32. As a result, the display unit 33 replays and displays the image of the captured image data recorded in the memory card 40.

In addition, it is possible to cause the display unit 33 to display user interface images (operation images) along with the above-mentioned through-the-lens image and the replayed image of the image data. In this case, the control unit 27 generates a display image data as a necessary user interface image in accordance with the operation state at that time, for example, and outputs the display image data to the display driver 32. With this configuration, the display unit 33 displays the user interface images. In this regard, these user interface images can be displayed on the display screen of the display unit 33 separately from a monitor image such as a specific menu screen and a replayed image of the captured image data, or it can be displayed so as to overlap and synthesize on a part of the monitor image or the replayed image of the captured image data.

The control unit 27 includes a CPU (Central Processing Unit) in practice, and the control unit 27 constitutes a microcomputer with a ROM 28, RAM 29, and the like. The ROM 28 stores various pieces of setting information regarding the operations of the digital still camera 1 in addition to the programs to be executed by the CPU as a control unit 27. The RAM 29 functions as a main storing device for the CPU.

In addition, the flash memory 30 in this case is provided as a nonvolatile storage area used for storing various pieces of setting information of which a change (rewriting) may be necessary in accordance with the user's operation or the operation history. Moreover, when a nonvolatile memory such as a flash memory is employed for the ROM 28, a part of the storage area in the ROM 28 can be used instead of the flash memory 30.

An operating unit 31 indicates both various manipulators provided in the digital still camera 1 and an operation information signal output part which generates an operation information signal in accordance with the operation which is made with respect to these manipulators and outputs the operation information signal to the CPU. The control unit 27 executes predetermined processing in accordance with the operation information signal input from the operating unit 31. As a result, operations of the digital still camera 1 are executed in response to the user's operation.

An audio output unit 35 is a part to be controlled by the control unit 27 for outputting electronic sounds of predetermined tones and pronunciation patterns for predetermined notifications, for example.

An LED unit 36 includes an LED (Light Emitting Diode) which is provided so as to appear in the front face portion of the case of the digital still camera 1 and a circuit unit for driving the LED to turn it on, and turns on and off the LED in response to the control by the control unit 27. The predetermined notifications are made by the patterns of turning on and off the LED.

A platform adaptive communication unit 34 is a part for executing a communication between the platform 10 and the digital still camera 1 by a predetermined communication method, and includes, in the state in which the digital still camera 1 is attached to the platform 10, a physical layer configuration for making it possible to exchange communication signals with the communication unit on the side of the platform 10 by a wired or wireless communication and a configuration for executing communication processing corresponding to a predetermined layer whose level is upper than that of the physical layer configuration. A connector part connected to the connector 14 in FIG. 2 is included in the above-mentioned physical layer configuration.

### 1-3. Platform

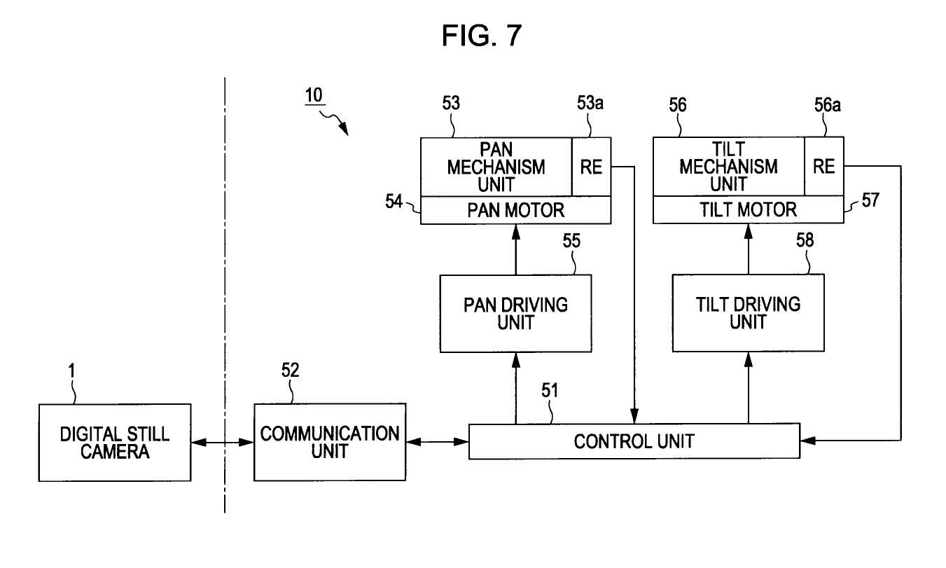

FIG. 7 is a block diagram illustrating an internal configuration of the platform 10.

As described above, the platform 10 is provided with the pan and tilt mechanisms, and includes a pan mechanism unit 53, a pan motor 54, a tilt mechanism unit 56, and a tilt motor 57 as the parts corresponding to the pan and tilt mechanisms.

The pan mechanism unit 53 includes a mechanism for providing the digital still camera 1 attached to the platform 10 with a motion in the pan (horizontal, right and left) direction shown in FIG. 4. The motion of this mechanism can be obtained by the pan motor 54 rotating in the forward and reverse direction. In a similar manner, the tilt mechanism unit 56 includes a mechanism for providing the digital still camera 1 attached to the platform 10 with a motion in the tilt (vertical, upper and lower) direction shown in FIG. 5B. The motion of this mechanism can be obtained by the tilt motor 57 rotating in the forward and reverse direction.

The control unit 51 includes a microcomputer formed by the combination of the CPU, the ROM, and the RAM, and controls the motions of the pan mechanism unit 53 and the tilt mechanism unit 56. For example, when controlling the motion of the pan mechanism unit 53, the control unit 51 outputs the signal for instructing a direction in which the pan mechanism unit 53 is to be moved and a movement velocity, to a pan driving unit 55. The pan driving unit 55 generates a motor driving signal corresponding to the input signal, and outputs the generated motor driving signal to the pan motor 54. This motor driving signal is a pulse signal corresponding with a PWM control when the motor is a stepping motor, for example.

The pan motor 54 rotates in a predetermined rotation direction with a predetermined rotation velocity by the motor drive signal. As a result, the pan mechanism unit 53 is driven to move in the movement direction and with the movement velocity corresponding to the rotation of the pan motor 54.

In a similar manner, when controlling the motion of the tilt mechanism unit 56, the control unit 51 outputs a signal for instructing a movement direction and a movement velocity necessary for the tilt mechanism unit 56, to the tilt driving unit 58. The tilt driving unit 58 generates a motor driving signal corresponding to the input signal, and outputs the generated motor driving signal to the tilt motor 57. The tilt motor 57 rotates in a predetermined rotation direction with a predetermined rotation velocity by the motor drive signal. As a result, the tilt mechanism unit 56 is driven to move in the movement direction and at the movement velocity corresponding to the rotation of the tilt motor 57.

In addition, the pan mechanism unit 53 is provided with a rotary encoder (a rotation detector) 53a. The rotary encoder 53a outputs a detection signal indicating a rotation angle amount to the control unit 51 in accordance with the movement of rotation of the pan mechanism unit 53. In a similar manner, the tilt mechanism unit 56 is provided with a rotary encoder 56a. This rotary encoder 56a also outputs a signal indicating a rotation angle amount to the control unit 51 in accordance with the movement of rotation of the tilt mechanism unit 56.

The communication unit 52 is a part for executing a communication with the platform adaptive communication units 34 in the digital still camera 1 attached to the platform 10 by a predetermined communication method. In the same manner as in the platform adaptive communication unit 34, the communication unit 52 includes a physical layer configuration for making it possible to exchange communication signals with the counterpart communication unit by a wired or wireless communication and a configuration for executing communication processing corresponding to a predetermined layer whose level is upper than that of the physical layer configuration. The connector 14 of the camera base part 12 in FIG. 2 is included in the above-mentioned physical layer configuration.

### 2. Functional Configuration Example Corresponding with Composition Control According to Embodiments

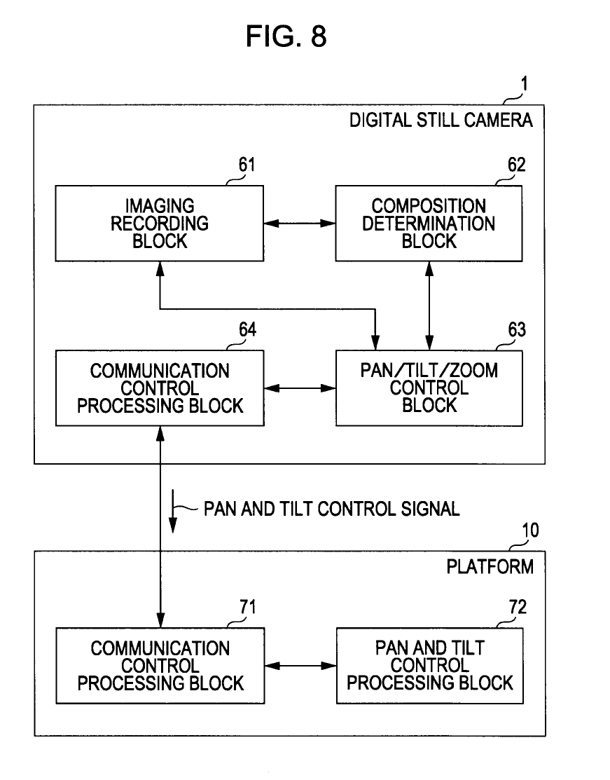

Next, FIG. 8 is a block diagram illustrating an example of a functional configuration of the digital still camera 1 and the platform 10 constituting the imaging system according to the embodiments of the invention, which is implemented by hardware and software (a program).

In this drawing, the digital still camera 1 includes an imaging recording block 61, a composition determination block 62, a pan/tilt/zoom control block 63, and a communication control processing block 64.

The imaging recording block 61 is a part for obtaining images obtained by imaging as image signal data (the captured image data), and executes a control processing for storing the captured image data in a storing medium. This part includes an optical system for imaging, an imaging element (an image sensor), a signal processing circuit for generating the captured image data from the signal output from the imaging element, and a recording control and processing system for writing and recording (storing) the captured image data in the storage medium, for example.

The recording of the captured image data (imaging recording) in the imaging recording block 61 in this case is executed by the instruction and the control of the composition determination block.

The composition determination block 62 imports and inputs the captured image data output from the imaging recording block 61, first executes the subject detection based on the captured image data, and finally executes a processing for the composition determination.

In the embodiments of the present invention, when executing the composition determination, the composition determination block 62 detects the attribution of each subject detected in the subject detection which will be described later. In the composition determination processing, the optimal composition is determined using the detected attribution. Moreover, a composition adjusting control is also performed to obtain the captured image data of the image content in the determined composition.

Here, the subject detection processing (including the setting of an initial face frame) executed by the composition determination block 62 may be configured to be executed by the signal processing unit 24 in FIG. 6. In addition, the subject detection processing by the signal processing unit 24 can be implemented as an image signal processing by a DSP (Digital Signal Processor). That is, it can be implemented by a program and instruction provided to the DSP.

Furthermore, the modification of the face frame, the composition determination, and the composition adjustment control, which are executed by the composition determination block 62, can be implemented as the processing executed by the CPU as a control unit 27 following a program.

The pan/tilt/zoom control block 63 executes the pan/tilt/zoom control such that the composition and the field-of-view range in accordance with the determined optimal composition can be obtained, in response to the instruction of the composition determination block 62. That is, as a composition adjustment control, the composition determination block 62 provides an instruction for the composition and the field-of-view range to be obtained in accordance with the determined optimal composition to the pan/tilt/zoom control block 63, for example. The pan/tilt/zoom control block 63 obtains a movement amount of the pan and tilt mechanisms of the platform 10 such that the digital still camera 1 faces in the imaging direction in which the instructed composition and field-of-view range can be obtained. Then, the pan/tilt/zoom control block 63 generates a pan and tilt control signal for instructing the movement in accordance with the obtained movement amount.

In addition, the pan/tilt/zoom control block 63 obtains the position of the zoom lens (zooming magnification) in order to obtain the image angle which was determined to be appropriate, and controls a zooming mechanism provided in the imaging recording block 61 such that the zoom lens is in the obtained position.

In addition, the communication control processing block 64 is a part for executing a communication with a communication control processing block 71 provided on the side of the platform 10 while following a predetermined communication protocol. The pan and tilt control signal generated by the pan/tilt/zoom control block 63 is transferred to the communication control processing block 71 of the platform 10 by the communication of the communication control processing block 64.

The platform 10 includes the communication control processing block 71 and a pan and tilt control processing block 72 as shown in the drawing, for example.

The communication control processing block 71 is a part for executing a communication with the communication control processing block 64 on the side of the digital still camera 1. When receiving the pan and tilt control signal, the communication control processing block 71 outputs the pan and tilt control signal to the pan and tilt control processing block 72.

The pan and tilt control processing block 72 has a function of executing the processing regarding the pan and tilt controls from among the control processing executed by the control unit 51 (the microcomputer) on the side of the platform 10 shown in FIG. 7, for example.

This pan and tilt control processing block 72 controls a pan driving mechanism unit and a tilt driving control mechanism unit not shown in the drawing, in accordance with the input pan and tilt control signal. As a result, the panning and the tilting for obtaining a necessary horizontal view angle and a necessary vertical view angle in accordance with the optimal composition are performed.

In addition, the pan/tilt/zoom control block 63 can perform the pan/tilt/zoom controls for searching for the subject in response to the instruction by the composition determination block 62, for example.

### 3. Basic Algorithm Example of Automatic Imaging and Recording Operations

In the imaging system configured as described above, the pan and tilt mechanisms of the platform 10 are driven to change the field-of-view range of the digital still camera 1, and then the subject which appears in the captured image is detected. Then, the detected subject, if any, can be arranged within the image frame of a desirable composition, and imaged and recorded. That is, the imaging system has an automatic imaging and recording functions.

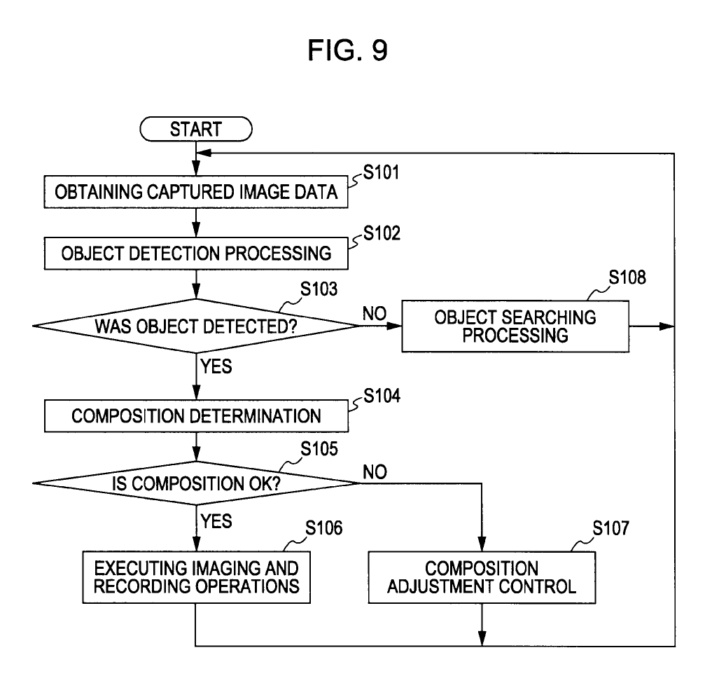

The flowchart of FIG. 9 shows an example of an algorithm for such automatic imaging and recording operations. In this regard, the algorithm shown in this drawing is a basis of the algorithms in the first to fourth embodiments which will be describe later.

Moreover, it can be considered that the processing method shown in this drawing is appropriately executed by each functional block (the imaging recording block 61, the composition determination block 62, the pan/tilt/zoom control block 63, or the communication control processing block 64) in the digital still camera 1 shown in FIG. 8.

In FIG. 9, the composition determination block 62 first imports and obtains the captured image data which can be obtained at that time by the imaging recording block 61 in step S101, and executes the subject detection processing on the captured image data in step S102.

In the subject detection processing of the step S102, the face detection technique is applied as described above, and the number of the subjects, the size of the subject, the subject position in the image, and the like can be obtained as the detection result.

Next, in the step S103, the composition determination block 62 determines whether or not the subject was detected by the subject detection process in the step S102. Here, when the composition determination block 62 determines that the subject was not detected, the composition determination block 62 starts a subject searching processing in the step S108, and then the processing returns to the step S101.

In this subject searching processing, the pan/tilt/zoom control block 63 instructs through the communication control processing block 64, the platform 10 to move in the pan and tilt directions, and performs the zoom control, if necessary, to control the change of the field-of-view range by a predetermined pattern with the passage of time. The subject searching processing is performed in order to capture the subject which exists near the digital still camera 1 so as to be arranged in the field-of-view range.

On the other hand, when the composition determination block 62 determines in the step S103 that the subject was detected, the process proceeds to the step S104.

In the step S104, the composition determination block 62 determines the optimal composition in accordance with the detected subject.

The size of the subject in the image frame, the subject position in the image frame, and the like can be exemplified as components which form the composition, which are determined here. Then, the composition adjustment control is performed so as to obtain this determined composition as the image content in the image frame of the captured image data.

Thereafter, when the composition adjustment control was performed, the composition determination block 62 determines in the step S105 that the composition obtained at that time is the same as the determined composition and whether the timing is good for the imaging and recording operations (if the composition is OK).

For example, when the determination that “the composition is OK” is not obtained even after the elapse of a predetermined time period, a negative determination result is obtained in the step S105. In this case, the composition adjustment control is executed in the step S107 so as to obtain the determined composition as the image content in the image frame of the captured image data. That is, the pan and tilt controls so as to obtain the subject position in the frame in accordance with the determined composition, the zoom control so as to obtain the subject size in accordance with the determined composition, and the like are performed.

On the other hand, when the positive determination result is obtained in the step S105, the process proceeds to the step S106.

In the step S106, the imaging recording block 61 is instructed to perform the imaging and recording operations. In response to this instruction, the imaging recording block 61 executes the operation to record the captured image data obtained, as a still image file at that time in the memory card 40.

According to the algorithm shown in FIG. 9, when the subject is detected, the operation to image and record the detected subject in an appropriate composition is executed automatically. That is, it is possible to obtain the automatic imaging and recording operations for automatically recording the captured image data of the image including, for example, a person as a subject.

### 4. First Embodiment

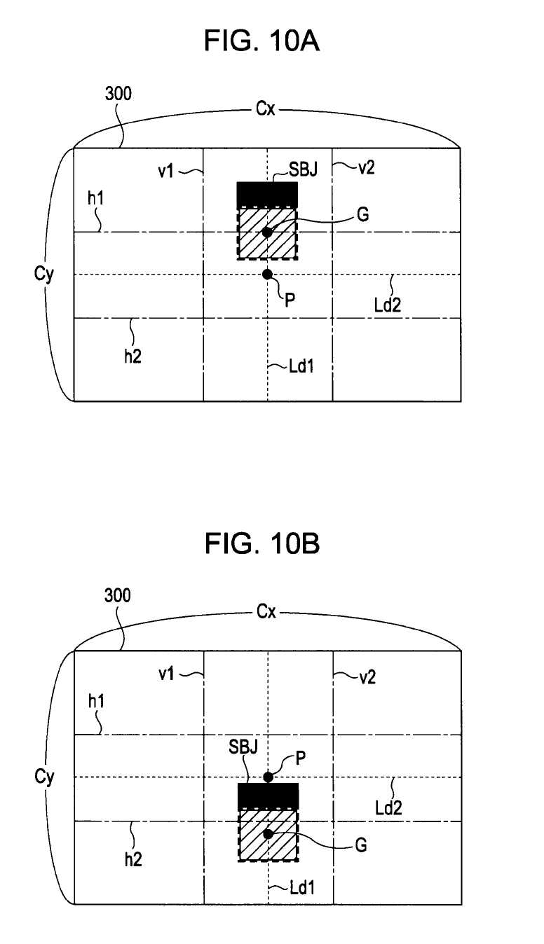

Here, a case is assumed in which one subject SBJ is detected in the course of executing the automatic imaging and recording operations by following the algorithm shown in FIG. 9, for example. In addition, the composition determined in the step S104 is assumed to be the one shown in FIG. 10A, for example.

FIG. 10A shows the subject SBJ detected in an image frame 300 corresponding to the image of the captured image data. The image corresponding to the image frame 300 shown in FIG. 10A has a horizontal image size (a horizontal pixels) Cx and the vertical image size (a vertical pixels) Cy.

Supposed lines of a vertical reference line Ld1, a horizontal reference line Ld2, vertical parting lines v1 and v2, and horizontal parting lines h1 and h2 are shown respectively in the same drawing for the explanation of the subject position.

The vertical reference line Ld1 is a vertical line which equally divides the horizontal image size Cx into two parts while passing through the midpoint thereof. The horizontal reference line Ld2 is a horizontal line which equally divides the vertical image size Cy into two parts while passing through the midpoint thereof. In addition, the intersection between the vertical reference line Ld1 and the horizontal reference line Ld2 corresponds to the reference coordinate P in the image frame 300, for example. This reference coordinate P corresponds to the imaging optical axis of the digital still camera 1.

The horizontal parting lines h1 and h2 are two straight lines which equally divide the horizontal image size Cx into three parts, where the horizontal parting line h1 locates on the left side, and the horizontal parting line h2 locates on the right side.

The vertical parting lines v1 and v2 are two straight lines which equally divide the vertical image size Cy into three parts, where the vertical parting line v1 locates on the upper side, and the vertical parting line v2 locates on the lower side.

A subject gravity center G is also shown in the image of the subject SBJ. This subject gravity center G is the information representing the subject position, and can be obtained by a predetermined algorithm as one coordinate point in the image area of the face part detected as a subject at the time of the subject detection processing.

The composition shown in FIG. 10A can be described as follows when seen from the subject position.

That is, the subject gravity center G corresponds to a coordinate which passes through the horizontal reference line Ld1, that is, a midpoint in the horizontal direction in the horizontal direction, and is positioned on the horizontal parting line h1, that is, at the position of ⅓ from the top with respect to the horizontal image size Cy in the vertical direction.

In addition, for example, if this composition can be obtained after finally executing the composition adjustment control, the determination result representing that “the composition is OK” can be obtained, and then the imaging and recording operations are performed in step S105.

However, there is a case in which it is difficult to adjust to the determined composition depending on the positional relationship between the subject SBJ and the imaging system.

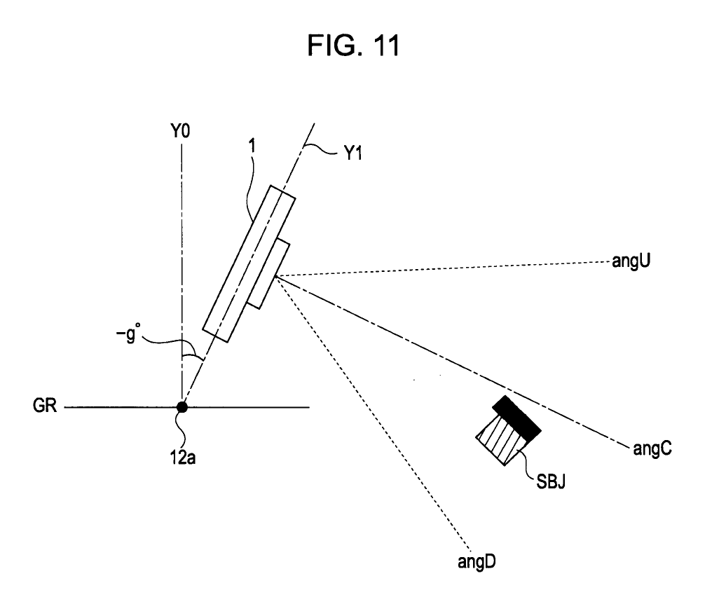

For example, FIG. 11 shows a state in which the digital still camera 1 viewed from the side face direction is in a tilt position of the maximum rotation angle −g°. Although the state of the digital still camera 1 shown in this drawing can be obtained by attaching it to the platform 10 in practice, the platform 10 is not shown in this drawing.

In addition, this drawing shows the image angles in the vertical direction as the image angles set by the digital still camera 1, using an image angle center angC, an image angle upper end angU, and an image angle lower end angD. Moreover, the image angle center angC coincides with the imaging optical axis of the digital still camera 1, and the angle from the image angle center angC to the image angle upper end angU is equal to the angle from the image angle center angC to the image angle lower end angD. The range from the image angle upper end angU to the image angle lower end angD corresponds to the field-of-view range in the vertical direction. It is assumed here for the explanation's sake that the field-of-view range is set to the widest image angle (the wide ends).

The digital still camera 1 as described above is in a state in which the depression angle reaches its limitation position. That is, the field-of-view range of the digital still camera 1 is not allowed to be changed in a lower direction any more.

On the other hand, there is a case in which the subject SBJ is positioned lower than the image angle center angC as shown in the drawing.

FIG. 10B shows the image which was captured in the state shown in FIG. 11 by the digital still camera 1.

In FIG. 10B, the position of the subject gravity center G is the same as in the determined composition in the horizontal direction. However, the position of the subject gravity center G is obviously in a lower area than the horizontal reference line Ld2 in the vertical direction. As described above, since the field-of-view range of the digital still camera 1 is not allowed to face further lower than the present state, the subject position in the image frame 300 is not allowed to be moved to an upper position than the position shown in FIG. 10B. That is, the position of the subject gravity center G in the vertical direction does not coincide with the one in the determined composition in this case.

In this case, if the process follows the algorithm shown in FIG. 9, a negative determination result representing that the composition is not OK is obtained in the step S105, the process proceeds to the step S107, and then returns to the step S101 after executing the composition adjustment control.

In the composition control in the step S107 at this time, the composition determination block 62 instructs the platform 10 to rotate the tilt mechanism in the depression angle direction, for example.

However, even if receiving this instruction, the platform 10 is not allowed to rotate the tilt mechanism unit in the depression angle direction any more.

Therefore, the imaging system is not allowed to proceed to the subsequent operations while it stays in the state shown in FIG. 10B, in this case.

The same problem may occur in the movement in the pan direction.

Basically, the platform 10 according to the embodiments can freely rotate by 360° or more in the pan direction. However, when the user performed the operation of the limitation setting of the rotation angle, or when a cable was inserted into the rear surface of the platform 10, the rotation angle of the platform 10 is limited to, for example, 180°, 90°, or the like. When the pivotable angle in the pan direction is limited in this manner, the position of the imaging system which has rotated up to the set pivotable angle corresponds to the limitation position.

Here, it is assumed that the imaging system is rotated in the pan direction so as to adjust the composition to the detected subject, and reaches the limitation position. At this time, the state may naturally happen in which the subject position in the horizontal direction is not the same as that in the determined composition even if the imaging system is not rotated further than the limitation position.

There is a case in which the same subject position in the determined composition is not obtained in the image depending on the positional relationship between the imaging system and the subject. Since it is difficult to avoid this situation, it is necessary to configure the imaging system to execute appropriate operations corresponding with this situation as the operation sequence in the automatic imaging and recording operations. As a result, it is possible to implement more effective and intelligent operations of the automatic imaging and recording.

Hereinafter, the description of the first to fourth embodiments will be made of the configurations so as to obtain the appropriate operations corresponding with the situation in which the subject is positioned where the determined composition is not obtained when the automatic imaging and recording operations are performed.

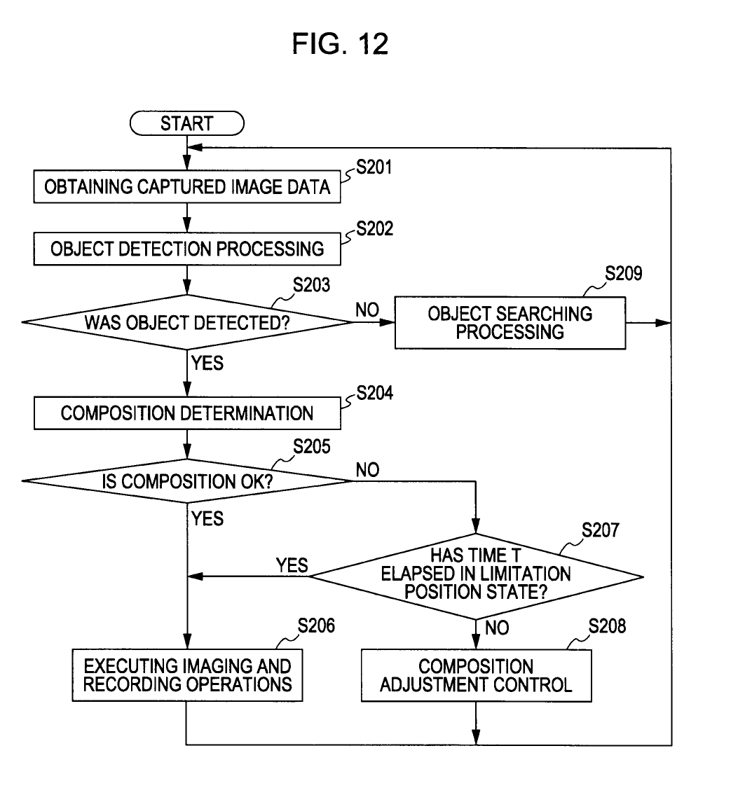

FIG. 12 shows an example of an algorithm of the automatic imaging and recording operations according to the first embodiment of the invention.

In the same drawing, the steps S201 to S206, 5208, and S209 are the same as the step S101 to S106, 5107, and S108 in FIG. 9.

In FIG. 12, when a negative determination result representing that the determined composition is not obtained is obtained in the step S205, the process proceeds to the step S207.

In the step S207, it is determined whether or not at least any one of the pan mechanism and the tilt mechanism is in the limitation position, and a time T has elapsed in the state in the limitation position. In this regard, the digital still camera 1 (the composition determination block 62) can recognize whether or not any one of them is in the limitation position, by the notification from the side of the platform 10. The control unit 51 of the platform 10 in this case is configured to notify the digital still camera 1 of the fact that each of the pan and tilt mechanisms is in the limitation position.

For example, when neither the pan mechanism nor the tilt mechanism reaches the limitation position, or when the time T has not elapsed since the timing of reaching the limitation position while at least any one of the pan mechanism and the tilt mechanism is in the limitation position, a negative determination result is obtained in the step S207.

In this case, the pan control or the tilt control for the composition adjustment control is performed in the step S208, and the process returns to the step S201.

On the other hand, when the negative determination result representing that the time T has elapsed in the state of the limitation position is obtained in the step S207, the process proceeds to the step S206 to execute the imaging and recording operations.

That is, the imaging system according to the first embodiment of the invention is configured so as to obtain the imaging and recording operations even if the composition is not OK at the time when the pan position or the tilt position reaches the limitation position, and the predetermined time T has elapsed. That is, according to the first embodiment, the imaging system is configured to record the image obtained at the time when the predetermined time has passed even if the determined composition has not been obtained.

### 5. Second Embodiment

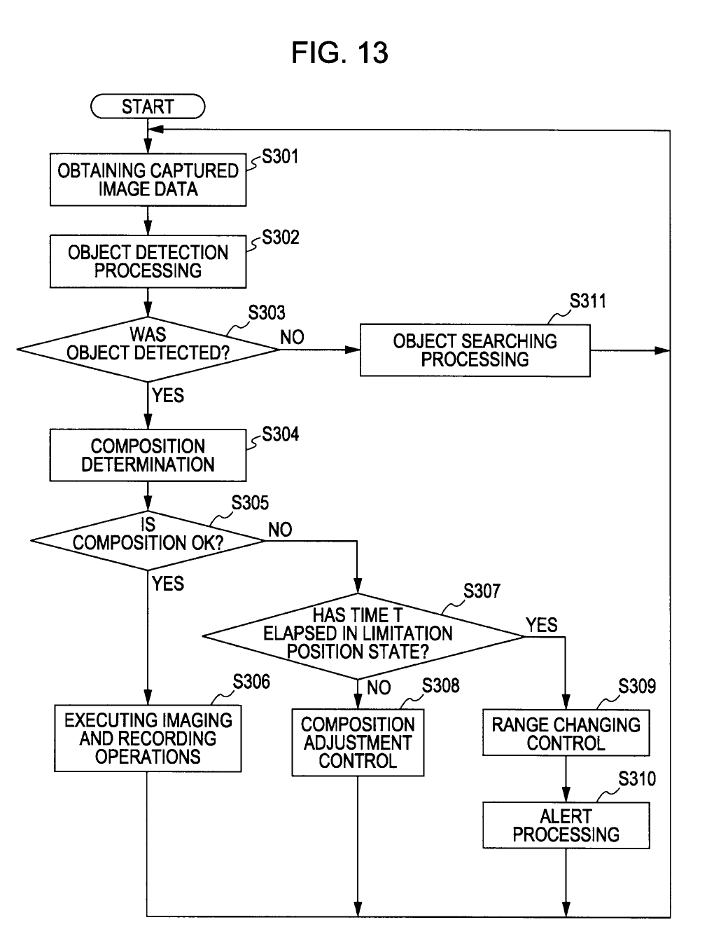

FIG. 13 shows an algorithm example of the automatic imaging and recording operations according to the second embodiment of the invention.

The operation determined according to the second embodiment of the invention is the operation for searching for another subject, for which the determined composition may be obtained, without executing the imaging and recording operations when the predetermined time T has elapsed since the time when the pan position or the tilt position reached the limitation position while the determined composition was not obtained.

In the same drawing, the steps S301 to S308, and S311 are the same as the steps S201 to S208, and S209 in FIG. 12.

However, the time T determined in the step S307 may be differently set from that in the step S207 of FIG. 12, considering that it is necessary to obtain the appropriate operations according to the second embodiment.

In the state in which the negative determination result has been obtained in the step S307, the process proceeds to the step S308 to execute the composition adjustment control in the same manner as in FIG. 12.

On the other hand, when the positive determination result is obtained in the step S307, the process proceeds to the step S309 to execute the control to change the field-of-view range (field-of-view range changing control).

The field-of-view range changing control here is a control to execute the panning or the tilting so as to detect in the image of the captured image data, a subject (one or more) different from the target subject for which the composition adjustment control has been performed hitherto (finally), and change the field-of-view range in the horizontal direction.

As one example of this field-of-view range changing control, it can be considered that the field-of-view range is changed such that the subject which was the last target of the composition determination is positioned out of the field-of-view range. In order to do this, it is possible to obtain the pan rotation angle and the tilt rotation angle, by which the subject is positioned out of the field-of-view range, based on the subject position in the image frame 300 at the time when the pan position or the tilt position is in the limitation position, for example. For example, the pan rotation angle can be obtained by the distance from the vertical reference line Ld1 to the image of the subject SBJ and the image angle value at that time. In the same manner, the tilt rotation angle can be obtained by the distance from the horizontal reference line Ld2 to the image of the subject SBJ and the image angle value at that time.

The pan control or the tilt control may be performed such that the pan mechanism or the tilt mechanism moves by the pan rotation angle or the tilt rotation angle which is obtained in this manner. Thereafter, the process proceeds to the step S310, which will be described later, then returns to the step S301.

With the above-mentioned configuration, the imaging system according to the second embodiment performs the operations of searching another subject without executing the imaging and recording operations when the time T has elapsed without obtaining the determined composition in the limitation position state.

However, when the imaging system performs the operation of searching another subject without executing the imaging and recording operations as described above, the user, who was the subject and the target of the composition adjustment hitherto, may think that the imaging system suddenly shifted to the operation of searching another subject without imaging the user himself/herself although the user wanted to image himself/herself. At this time, the user does not typically recognize that he/she was in a position out of the range where the composition can be adjusted. Therefore, the user may feel uncomfortable in this case.

Accordingly, in FIG. 13, the processing for notifying the user of an alert is executed in the subsequent step S310 after the field-of-view range changing control in the step S309. That is, the imaging system performs the processing for notifying the user of the fact that the process proceeds to another operation of searching for another subject since the composition was not obtained.

In order to execute this notification processing, predetermined LEDs forming the LED unit 36 of the digital still camera 1 may be turned on and off by a predetermined pattern. Alternatively, the audio output unit 35 may output a predetermined alert sound.

Here, when comparing the operations in the first and second embodiments, it is considered to be important in the first embodiment that the image including the detected subject is to be imaged and recorded. On the other hand, it is considered to be important in the second embodiment that the image which is exactly the same as the determined composition is to be imaged and recorded.

There are some ways to determine which one of the operations in the first and second embodiments corresponds with the situation. The following is one of the examples.

The imaging system according to this embodiment can execute the imaging and recording operations using a self timer by a predetermined operation. Particularly, in this embodiment, the subject in the image is detected, and the composition determination is executed even when the imaging and recording operations are executed using the self timer. As a result, it is possible to execute the composition adjustment so as to obtain the determined composition.

At the time of imaging by the self timer, it is obvious that the user wants to execute the imaging and recording operations. In this case, it is necessary to consider that the execution of the imaging and recording operations is more important than obtaining the determined composition.

Accordingly, the algorithm in the second embodiment is employed at the time of imaging by the self timer.

On the other hand, the first embodiment is employed at an ordinary time when imaging is not executed using the self timer, while taking advantage of the composition control in the automatic imaging and recording operation according to the embodiment and taking the composition into serious account.

### 6. Third Embodiment

Here, in the determination processing corresponding to the step S205 in FIG. 12 (the first embodiment) and the step S305 in FIG. 13 (the second embodiment) regarding whether or not the determined composition has been obtained, the determination of whether or not the subject position is the same as that in the determined composition can be made in practice in the following manner, for example.

First, the subject position can be obtained as a target coordinate at which the subject gravity center G is to be positioned in the composition determination processing. This target coordinate is represented here as (x, y). Then, the pan control and the tilt control are performed as the composition adjustment control such that the subject gravity center G is positioned at this target coordinate (x, y).

When it is determined whether or not the subject position is the same as that in the determined composition in the step S205 in FIG. 12 or the step S305 in FIG. 13, a predetermined margin is given to each of the x coordinate and the y coordinate of the target coordinate. That is, if the margin of the x coordinate is represented as ±a, and the margin of the y coordinate is represented as ±b, it is determined whether or not the subject gravity center G is positioned within the range of the coordinate (x±a, y±b).

For example, a person as a subject is rarely in a completely stationary state, and he/she moves to some extent. Under such a situation, it is assumed that the algorithm is for determining whether or not the subject gravity center G is positioned exactly at the target coordinate (x, y) when it is determined whether or not the subject position is the same as that in the determined composition. In this case, there may occur a problem in that, for example, the determination result representing that the subject position is OK is not obtained in the step S205 or S305, regardless of the fact that the subject position is acceptable for the image content.

As a result, the margin is set as described above, and the target coordinate provided with the margin is used for the determination in practice.

In addition, this can be also understood from the view point of the margin of the target coordinate as described above, that the algorithm in the first embodiment is the one for enlarging the margin of the target coordinate to almost infinity at the timing when the time T has elapsed in the limitation position state, and for making it possible to obtain the determination result representing that “the composition is OK” in the step S305.

The third embodiment is a combination of the algorithm for enlarging the margin of the target subject and the algorithm in the second embodiment.

That is, in the third embodiment, the margin set to the target coordinate is enlarged when the pan mechanism or the tilt mechanism reaches the limitation position in the pan or the tilt direction. However, not the infinite value as in the first embodiment but a predetermined finite value is set as the margin at this time. Then, the determination is made in this state regarding whether or not the determined composition has been obtained. When the time T elapsed without obtaining the determination result representing that “the composition is OK”, the process proceeds to the field-of-view range changing control.

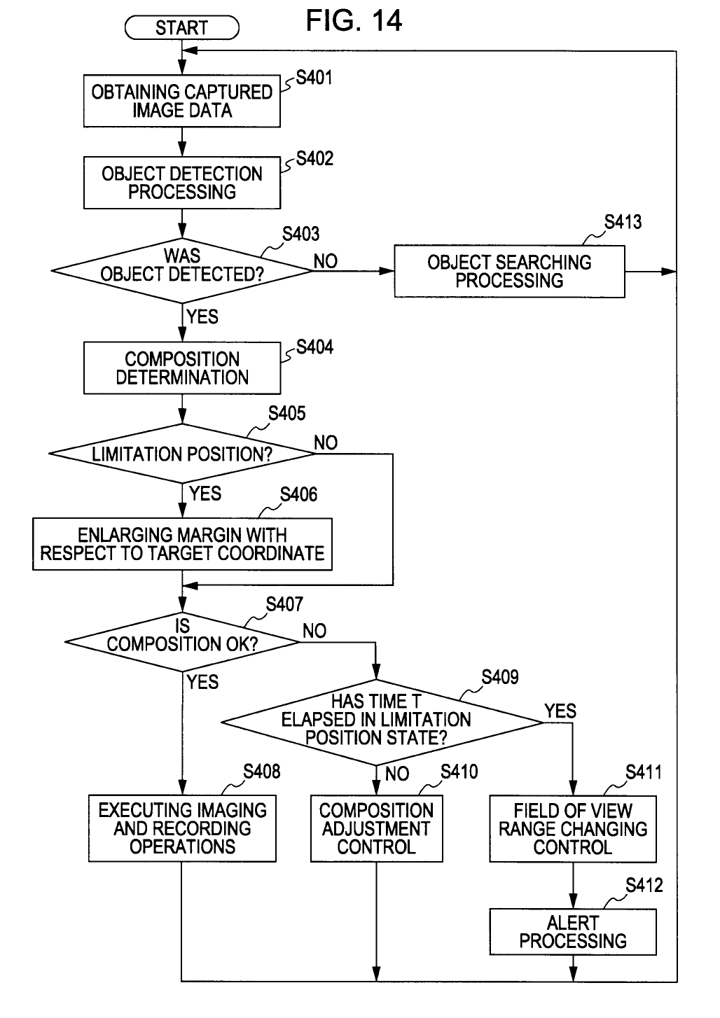

FIG. 14 shows an algorithm example of the automatic imaging and recording operations according to the third embodiment of the invention.

In the same drawing, the steps S401 to S404, and S407 to S413 are the same as the steps S301 to S304, and S305 to S311 in FIG. 13.

In FIG. 14, the determination is made regarding whether or not the pan position or the tilt position has reached the limitation position at that time in the step S405 after the composition determination processing in the step S404.

When the negative determination result was obtained in the step S405, the step S406 is skipped, and the process proceeds to the step S407. In the step S407 in this case, a target coordinate for which an ordinary margin without the enlargement was set is used for the determination regarding the subject position.

On the contrary, when the positive determination result was obtained in the step S405, the margin for the target coordinate is enlarged in the step S406. In this regard, both margins for the x coordinate and the y coordinate may be enlarged all the time in this margin enlargement processing in the step S406. However, another configuration may be applicable in which the imaging system selects one of the x coordinate and the y coordinate for which the margin is to be set in accordance with which one of the pan direction and the tilt direction has reached the limitation position. For example, it can be considered that the margin is enlarged only for the y coordinate, and the ordinary margin without the enlargement is set for the x coordinate when the tilt mechanism has reached the limitation position in the tilt direction while the pan mechanism has not reached the limitation position in the pan direction. This configuration is preferable since it is possible to obtain the coordinate, which is the same as that in the originally determined composition, for the direction in which a pan or tilt mechanism has not reached the limitation position.

By executing the subsequent processing from the step S407 after executing the processing in the steps S405 and S406 as described above, the determination is made regarding whether or not the determined composition has been obtained based on a more lenient criterion until the time T elapses in the state in which the pan or tilt mechanism reaches the limitation position. This results in a higher possibility in which the subject can be imaged and recorded in the composition which is closer to the determined composition to some extent. In addition, the field-of-view range is changed when the determined composition has not been obtained even after the elapse of the time T.

### 7. Fourth Embodiment

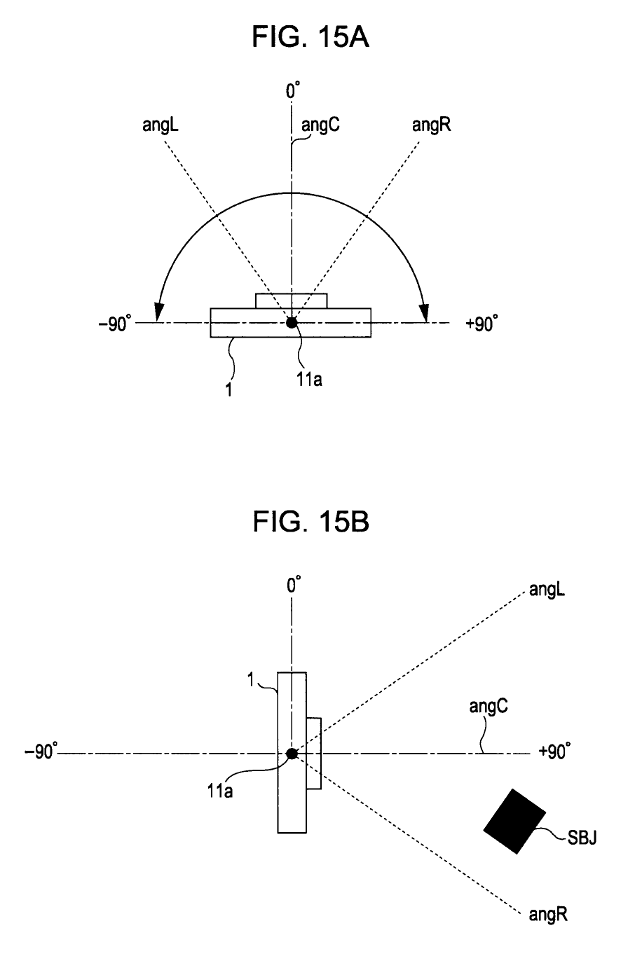

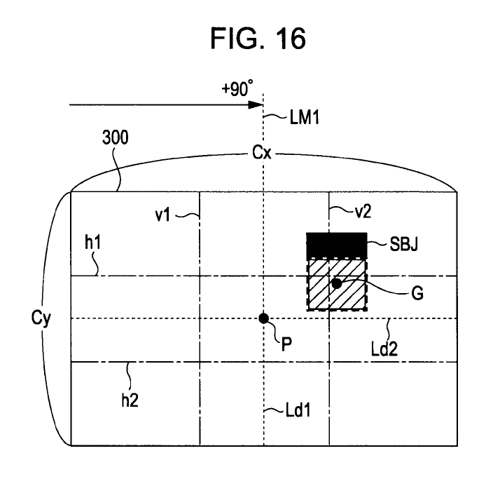

It can be considered that the relationship between the limited pivotable angle of the platform 10 and the image angle of the digital still camera 1 causes the phenomenon, which is the problem to be solved in this embodiment, in which it is difficult to obtain the target composition (the subject position in the image) regardless of the fact that the subject has been detected since the pan or tilt mechanism reached the limitation position in the pan or tilt direction. The description will be made of this point with reference to FIGS. 15A, 15B, and 16.

FIG. 15A is a top plan view of the digital still camera 1. This digital still camera 1 is attached to the platform 10, and the field-of-view range thereof is changed in the practical use. However, the platform 10 is not shown in this drawing for the simplification of the drawing.

Here, the image angles set for the digital still camera 1 are represented by the image angle center angC, the image angle left end angL, and the image angle right end angR. In addition, the image angle center angC coincides with the imaging optical axis of the digital still camera 1, and the angle from the image angle center angC to the image angle left end angL is the same as the angle from the image angle center angC to the image angle right end angR. The range between the image angle left end and L and the image angle right end angR corresponds to the field-of-view range in the horizontal direction. In this regard, it is assumed here that the widest image angle (wide ends) has been set for the explanation's sake.

In addition, in this case, the pivotable angle of the platform 10 in the pan direction is limited within the range of ±90° with the reference of 0° in FIG. 15A.

FIG. 15B shows the state in which the platform 10 is in the pan position of +90°. That is, this drawing shows the state in which the pan position has reached the limitation position in the clockwise direction.

At this time, the image angle center angC of the digital still camera 1 coincides with the pan position of +90°. The field-of-view range of the digital still camera 1 in the horizontal direction is within the range from the image angle left end angL to the image angle right end angR with the image angle center angC positioned in its center. That is, it is possible for the field-of-view range of the digital still camera 1 to image the angle range from the image angle center angC to the image angle right end angR while exceeding the limitation position corresponding to the pan position of 90°.

In the state shown in FIG. 15B, it is assumed that a person as a subject SBJ exists in the right half image angle range which corresponds to the range from the image angle center angC (the pan position of +90°) to the image angle right end angR, the range exceeding the limitation position corresponding to the pan position +90°.

According to the above mentioned first to third embodiments, this subject SBJ is in the field-of-view range, and thereby detected as a subject by the subject detection processing. In addition, the composition determination is executed with respect to this subject. However, when it is necessary to move the subject SBJ in the image to the center side in the horizontal direction in order to obtain the determined composition, it is difficult to move the imaging direction in the clockwise direction any more.

As can be understood from the above description, the digital still camera 1 has the image angle which can image to the area exceeding the limitation position of the pivotable range even if the pivotable ranges of the platform 10 in the pan and tilt directions are limited to certain angles. Accordingly, when a person exists in the position within the field-of-view range even if the person exists outside the movable range of the imaging system, the person can be detected as the subject without problems. This results in the phenomenon in which it is difficult to obtain the composition of the detected subject, which is the same as the determined composition.

This problem occurs more seriously as the image angle of the digital still camera becomes wider.

From such a viewpoint, it is possible to employ the configuration in which the subject, which was detected outside the originally assumed field-of-view range because of the wide image angle of the digital still camera 1, is not considered as a target of the composition determination from the beginning.

According to the fourth embodiment, the algorithm of the automatic imaging and recording operations is constructed based on this idea. Such an algorithm, as a result, makes it possible to omit a series of wasteful processing for executing the composition determination with respect to the subject for which the determination composition is not consequently obtained and executing the composition adjustment control to determine whether or not the composition is OK. As a result, it is possible to perform the automatic imaging and recording operations more efficiently.

According to the fourth embodiment of the invention, the algorithm of the automatic imaging and recording operations is constructed as follows.

First, FIG. 16 shows the image content of the captured image data which is obtained correspondingly to the state shown in FIG. 15B. As already described above, since the image angle center angC corresponds with the imaging optical axis in the horizontal direction, it corresponds to the vertical reference line Ld1 in the image frame 300 shown in FIG. 16. In this case, since the image angle center angC coincides with the pan position of +90° as shown in FIG. 15B, the vertical reference line Ld1 corresponds to the pan position of +90°.

The subject SBJ is positioned in the range from the image angle center angC to the image angle right end angR in FIG. 15B. In accordance with this positional relationship, the subject SBJ in the image shown in FIG. 16 is positioned in an area further right than the vertical reference line Ld1 in the image frame 300.

According to the fourth embodiment, assuming that the platform 10 is in the limitation position in the pan direction, the vertical line passing through the x coordinate of the target coordinate for the composition which was determined for the subject detected in this limitation position is set to be a horizontal limitation border LM1.

Here, it is assumed that the x coordinate of the target coordinate which is obtained in the composition determined for the subject detected as shown in FIG. 16 is the same as the reference coordinate P. That is, it is necessary that the target coordinate is positioned on the vertical reference line Ld1. As a result, the vertical limitation border LM1 in FIG. 16 is a vertical line passing through the reference coordinate P similarly to the vertical reference line Ld1.

In this case, the vertical reference line Ld1 coincides with the vertical limitation border LM1 as a result of the composition determinations only because the x coordinate of the target coordinate is positioned on the vertical reference line Ld1. There is a case in which the x coordinate of the target coordinate is not positioned on the vertical reference line Ld1 depending on the composition determination result. The vertical limitation border LM1 is necessarily set to be a straight line passing through the x coordinate of the target coordinate in the determined composition.

In FIG. 16, the following relationship can be found between the vertical limitation border LM1 set in the above-mentioned manner and the subject gravity center G of the subject SBJ.

In this case, it is difficult to move the field-of-view range any more beyond the limitation position for the subject SBJ which exists in the area further right than the vertical limitation border LM1 in the image frame 300. Accordingly, it is difficult to move the subject gravity center G to the x coordinate as a target coordinate, that is, onto the vertical limitation border LM1. On the contrary, if the subject gravity center G exists in the area further left than the vertical limitation border LM1 in the image frame 300, the field-of-view range can be moved in the pan direction within the range not exceeding the limitation position, to the left side. That is, it is possible to move the subject gravity center G onto the vertical limitation border LM1.

As described above, the area further right than the vertical limitation border LM1 in the image frame 300 is the area in which it is difficult to obtain the target x coordinate even if the subject gravity center G exists there, when the pan mechanism rotates in a positive pan movement direction (in the clockwise direction). This area is an area outside the limitation border.

On the other hand, the area further left than the vertical limitation border LM1 in the image frame 300 is an area in which it is possible to obtain the target x coordinate if the subject gravity center G is positioned there. That is, this area is an area inside the limitation border.

According to the fourth embodiment, if it is known in advance that the subject gravity center G as the subject position with respect to the imaging system as a basis exists in the area outside the limitation border, this subject is not considered as a target of the composition determination from the beginning.

Although the description was made of the movement in the horizontal direction, that is, the pan direction with reference to FIGS. 15A, 15B and 16, the same configuration can be applied to the movement in the tilt direction in the fourth embodiment.

That is, a horizontal limitation border LM2 is also set, and the areas outside and inside the limitation border are set in the upper and lower parts of the image frame as shown in FIGS. 15 and 16. In addition, if it is known in advance that the y coordinate of the subject gravity center G exists in the area outside the limitation border, this subject is not considered as a target of the composition determination from the beginning.

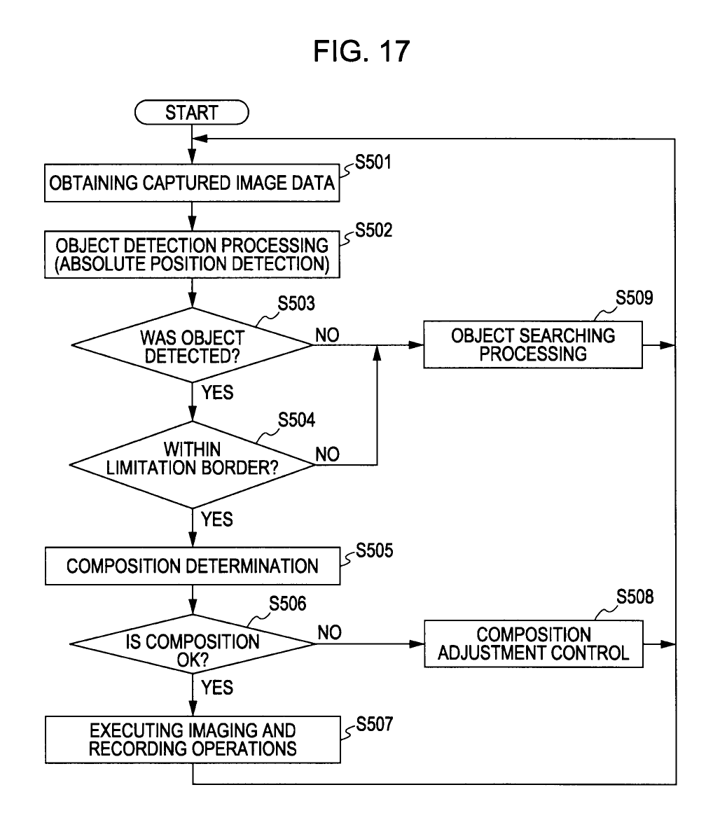

FIG. 17 is a flowchart illustrating the algorithm example of the automatic imaging and recording according to the fourth embodiment of the invention.

In the same drawing, the steps S501 to S503 and S505 to S509 are the same as the steps S101 to S103 and S104 to S108 in FIG. 9.

However, in the subject detection processing of the step S502 according to the fourth embodiment, the actual absolute position of the subject in the state in which the imaging system is set at that time is detected, and the position is obtained as the absolute position information.

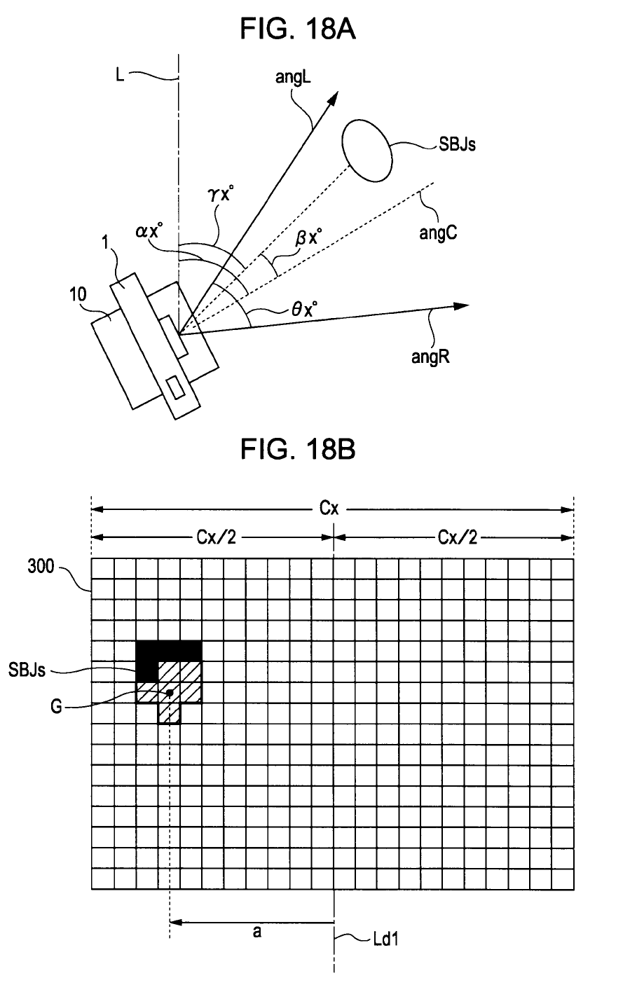

The description will be made of an example of the detection method of this absolute position information with reference to FIGS. 18A and 18B.

FIG. 18A shows a state in which the digital still camera 1 is in a position rotated in the clockwise direction by the pan angle αx° with respect to the reference line L (corresponding to the pan reference position (0°)), and the subject SBJ is imaged within the horizontal image angle. In this state, the horizontal image angle is represented as θx°, and the subject SBJ is positioned such that its center position (the gravity center) in the horizontal direction is on the line which is rotated in the counterclockwise direction by the angle βx° from the image angle center angC.

In addition, it can be seen from FIG. 18A that the subject SBJ is positioned such that the x coordinate of the subject gravity center G thereof is on the line which is rotated in the clockwise direction by the angle γx° from the reference line L.

Here, the reference line L is an absolute line which depends on the arrangement state of the platform 10 at that time. Accordingly, the position of the subject SBJ represented by the angle γx° is an absolute position based on the reference line L. That is, the position of the subject SBJ can be handled as the absolute position information. In this regard, the angle which can represent the absolute position of the subject such as the angle γx° is referred to as an absolute position correspondent angle. In addition, since the angle βx° represents the position of the subject SBJ which depends on the image angle center angC under the condition of the pan angle αx° at that time, it is referred to as a relative position correspondent angle.

The absolute position correspondent angle can be obtained as follows.

FIG. 18B shows a captured image which can be imaged an obtained by the digital still camera 1 in the position state shown in FIG. 18A.

Here, the horizontal image size (which can be represented as the number of pixels, for example) in the image frame 300 of the captured image is represented as Cx, and the vertical parting line which passes through the midpoint of the horizontal image size is represented as Ld1. Moreover, the vertical parting line Ld1 is used as a reference in the horizontal direction (a reference of the x coordinate: x=0) in the image frame of the captured image. The x coordinates along the horizontal direction are positive in the area further right than the vertical line M, and are negative in the area further left than the vertical line M. The coordinate value of the subject SBJ, which exists in the image frame 300 of the captured image, in the horizontal direction is represented as x=a. In addition, the x coordinate value a in the case of FIG. 18B is a negative value.

Here, the relationship (ratio) between the coordinate value a of the x coordinate to the gravity center of the subject SBJ and the horizontal image frame size Cx in FIG. 18B corresponds to the relationship (ratio) between the relative position correspondent angle βx° and the horizontal image angle θx° in FIG. 18A.

Accordingly, the relative position correspondent angle βx° can be represented by:

βx°=(a/Cx)*θx° (equation 1)

According to FIG. 18B, the relationship of the pan angle αx°, the relative position correspondent angle βx°, and the absolute position correspondent angle γx° can be represented by:

αx°=γx°−βx° (equation 2)

Accordingly, the absolute position correspondent angle γx° can be obtained as follows:

γx°=(a/Cx)*βx°αβx° (equation 3)

That is, the absolute position correspondent angle γx° is obtained by the parameters of the horizontal image frame size Cx, the x coordinate value a of the subject SBJ in the image frame of the captured image, the horizontal image angle θx°, and the pan angle αx°.

From among the parameters, the horizontal image frame size Cx is known in advance, and the x coordinate value β of the subject SBJ in the image frame of the captured image is the position information of the subject in the horizontal direction, which is detected within the captured image. Therefore, the x coordinate value a can be obtained by the subject detection processing according to this embodiment. In addition, the information regarding the horizontal image angle θx° can be obtained based on the information regarding the image angle (zooming) control. More specifically, it is possible to obtain the information regarding the horizontal image angle θx° by maintaining the information regarding the standard image angle at the time of setting the zoom ratio of the zoom lens provided in the optical system unit 21 to be x1, and using the zoom position which can be obtained in accordance with the zooming control and the above-mentioned standard image angle. In addition, the pan angle αx° can be also obtained as the information regarding the pan control.

As described above, it is possible to simply obtain the absolute position correspondent angle γx° without any problem according to the imaging system of this embodiment.

In practical use, the absolute position correspondent value (γy°) in the vertical direction is also obtained in the same manner. The absolute position correspondent angle γy° in the vertical direction can be obtained by the parameters of the horizontal image frame size Cy, the y coordinate value b of the subject SBJ in the image frame of the captured image (where the midpoint of the horizontal image frame size Cy is set to be y=0), the vertical image angle θy°, and the tilt angle αy° as follows:

γy°=(b/Cy)*θy°±αy° (equation 4)

just to be sure.

Next, when the positive determination representing that the subject was detected is obtained in the step S503, the process proceeds to the processing shown in the step S504.

In the step S504, the determination is made regarding whether or not the subject gravity center G of the subject detected this time is positioned within the limitation border both in the pan and the tilt directions.

In order to do this, first of all, the composition determination block 62 sets the vertical limitation border LM1 and the horizontal limitation border LM2 in the image frame 300 from the target coordinate which is obtained when the composition determination is executed with respect to the subject which was detected this time.

Next, the composition determination block 62 obtains the coordinate of the subject gravity center G in the image frame 300 when the field-of-view range corresponds to the limitation position, from the absolute position information of the subject which was detected this time.

Thereafter, the determination is made regarding whether or not the x coordinate of this subject gravity center G is positioned within the limitation border which is defined by the vertical limitation border LM1. In the same manner, the determination is made regarding whether or not the y coordinate of the subject gravity center G is positioned within the limitation border which is defined by the horizontal limitation border LM2.

Here it is assumed that the positive determination results are obtained both for the x coordinate and the y coordinate of the subject gravity center G in the step S504. In this case, the subject detected this time can move its subject gravity center G to the position which is exactly the same as that in the determined composition by the pan and tilt movements within the movable range up to the limitation position. Accordingly, in this case, the process proceeds to the processing after the step S505.

On the other hand, when the negative determination result is obtained for at least any one of the x coordinate and the y coordinate of the subject gravity center G in the step S504, the subject gravity center G is not allowed to be moved to the position which is exactly the same as that in the determined composition. Therefore, in this case, the process proceeds to the step S509 to execute the subject searching processing, and then returns to the step S501.

In this regard, when the negative determination result was obtained for only one of the x coordinate and the y coordinate of the subject gravity center G as another example of the step S504, it is possible to configure the imaging system which assumes that the positive determination result was finally obtained and proceeds to the processing after the step S505.

When the negative determination result was obtained for only one of the x coordinate and the y coordinate of the subject gravity center G, it is possible to obtain the coordinate position which is exactly the same as that in the determined composition for the direction for which the positive determination result was obtained. Accordingly, it is possible to consider that the composition which is suitably allowable has been obtained. Therefore, such an algorithm corresponds with the case in which it is important to execute the imaging and recording operations instead of the wide allowable range for the composition.

According to the algorithm shown in FIG. 17, when the negative determination result was obtained because the subject gravity center G was determined to be outside the limitation border in the step S504, the substantial composition control from the composition determination to the composition adjustment control shown as the steps S505 to S507 is not executed. That is, as already described above, the subject in the position to which the composition is not allowed to be adjusted is not considered as the target of the composition control, and accordingly it is possible to obtain the efficient operations of automatic imaging and recording.

### 8. Modified Example of Imaging System According to Embodiments

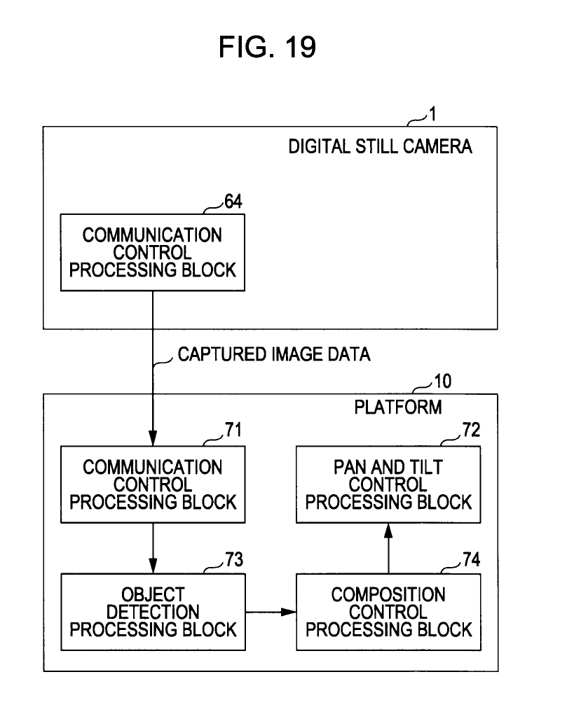

FIG. 19 shows a configuration example as the modified example of the imaging system according to this embodiment shown in FIGS. 7 and 8.

The imaging system shown in this drawing is configured to transfer the captured image data, which is generated by the signal processing unit 24 based on the imaging, from the digital still camera 1 to the platform 10 through the communication control processing block 64.

This drawing shows the communication control processing block 71, pan and tilt control processing block 72, the subject detection processing block 73, and the composition control processing block 74 as the configuration of the platform 10.

The communication control processing block 71 is a functional part corresponding to the communication unit 52 shown in FIG. 7, and configured to execute the communication processing with the communication control processing block 64 (the platform adaptive communication unit 34) on the side of the digital still camera 1 based on a predetermined protocol.

The captured image data received by the communication control processing block 71 is transferred to the subject detection processing block 73. This subject detection processing block 73 is provided with a signal processing unit which can execute at least the subject detection processing equivalent to that of the composition determination block 62 shown in FIG. 8. In addition, the subject detection processing block 73 executes the subject detection processing with respect to the imported captured image data, and outputs the detection information to the composition control processing block 74.

The composition control processing block 74 can execute the composition control equivalent to that of the composition determination block 62 shown in FIG. 8, and outputs the control signal to the pan and tilt control processing block 72 when executing the pan or tilt control as a result of the composition control processing.

The pan and tilt control processing block 72 has a function to execute the processing regarding the pan and tilt control from among the control processing which is executed by the control unit 51 shown in FIG. 7. In addition, the pan and tilt control processing block 72 outputs a signal to control the motion of the pan mechanism unit 53 and the tilt mechanism unit 56 in accordance with the input control signal to the pan driving unit 55 and the tilt driving unit 58. As a result, the panning and tilting operations are performed so as to obtain the composition which is determined by the composition determination block 62.

As described above, the imaging system shown in FIG. 19 is configured to cause the digital still camera 1 to transfer the captured image data to the platform 10 and execute the subject detection processing and the composition control on the basis of the imported captured image data on the side of the platform 10.

In addition, when the imaging system is configured to be able to execute the zooming control, the composition control processing block 74 may be configured to instruct the side of the digital still camera 1 to execute the zooming control through the communication control processing block 71.

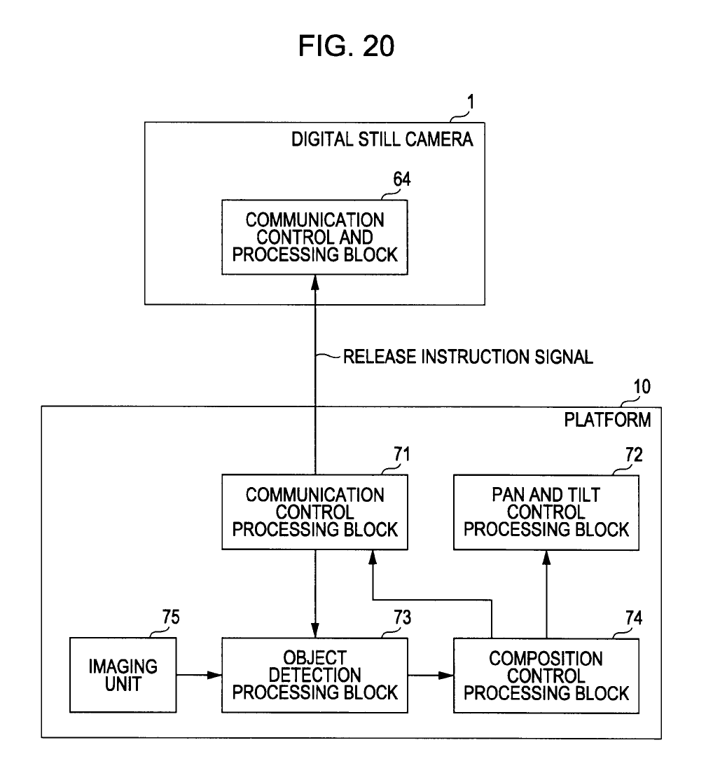

FIG. 20 shows a configuration example as another modified example of the imaging system according to this embodiment. In this drawing, the same reference numerals are attached to the same components as those in FIG. 19, and the description thereof is omitted.

This system is provided with an imaging unit 75 on the side of the platform 10. This imaging unit 75 is provided with an optical system and an imaging element (imager) for imaging, configured to obtain the signal (imaging signal) on the basis of the imaging light, and includes the signal processing unit for generating the captured image data from the imaging signal. This corresponds to the optical system unit 21, the image sensor 22, the A/D converter 23, and the signal processing unit 24 shown in FIG. 6, which are the signal processing stages until the captured image data is obtained. The captured image data generated by the imaging unit 75 is output to the subject detection processing block 73. In addition, the direction in which the imaging unit 75 imports the imaging light (the imaging direction) is set so as to coincide with the imaging direction of the optical system unit 21 (the lens unit 3) of the digital still camera 1 mounted on the platform 10 as much as possible.

The subject detection processing block 73 and the composition control processing block 74 in this case execute the subject detection processing and the composition control processing in the same manner as in FIG. 19. However, the composition control processing block 74 in this case causes the communication control processing block 71 to transfer the release instruction signal to the digital still camera 1 correspondingly to the timing at which the release operation is executed, in addition to the pan and tilt control. The digital still camera 1 is configured to execute the release operation in response to the reception of the release instruction signal.

According to another modified example described above, the platform 10 can execute all the control and processing regarding the subject detection processing and the composition control other than the release operation itself.

In the above-mentioned embodiment, the pan or tilt control executed as the composition control is executed by controlling the motion of the pan and tilt mechanisms of the platform 10. However, another configuration can be also employed in which the imaging light reflected by the reflection mirror is incident not to the platform 10 but to the lens unit 3 of the digital still camera 1, and the reflected light is moved so as to obtain the image, which can be obtained based on the imaging light, already subjected to the pan and tilt operations.

Moreover, if the pixel area for importing the imaging signal, which is effective as the image, from the image sensor 22 of the digital still camera 1 is controlled to shift in the horizontal and vertical directions, it is possible to obtain the image which is equivalent to the one which is subjected to the pan and tilt operations. In this case, it is not necessary to prepare the platform 10 or the equivalent device unit for the pan and tilt operations other than the digital still camera 1, and it is possible to cause the digital still camera 1 to execute all the composition control according to this embodiment alone.

In addition, the imaging system may be provided with a mechanism which can move an optical axis of the lens in the optical system unit 21 in the horizontal and the vertical directions. By controlling the motion of this mechanism, it is possible to execute pan and tilt operations.

In the above description, the imaging system according to this embodiment includes the digital still camera 1 and the platform 10 separately. However, the configuration is also applicable in which the imaging unit corresponding to the digital still camera 1 and the movable mechanism unit corresponding to the platform 10 are integrated in a single imaging device.

### 9. Application of Embodiments

### Trimming Processing

Next, the description is made of an example in which the configuration of the above-described embodiment is applied to the trimming processing.

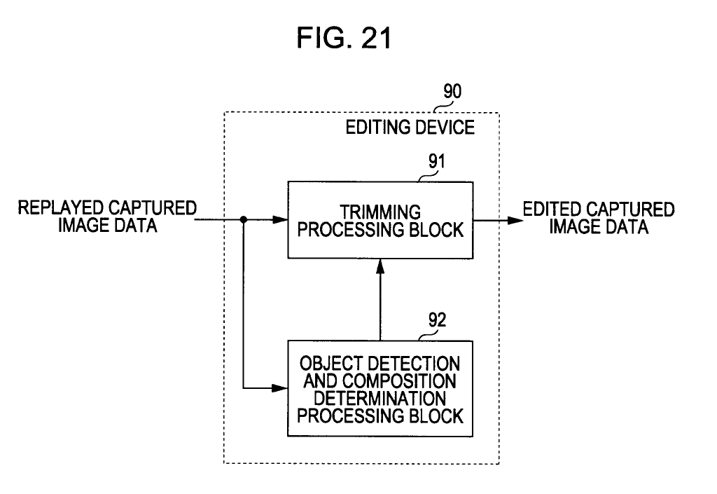

FIG. 21 shows the editing device 90. This editing device 90 executes image editing with respect to the existing image data.

Here, the editing device 90 is configured to obtain the image data (replayed image data) which is obtained by replay the image stored in a storing medium, for example, as the existing image data. In this regard, the editing device 90 may download and import the image data through the network in addition to replaying the image data from the storing medium. That is, there is no specific limitation for the way to obtain the captured image data to be imported by the editing device 90.

The replayed image data which was imported by the editing device 90 is input to the trimming processing block 91 and the subject detection and composition determination processing block 92, respectively.

First, the subject detection and composition determination processing block 92 executes the subject detection processing and outputs the detection information. Then, as the composition determination processing using this detection information, the subject detection and composition determination processing block 92 specifies the image part (the image part in the optimal composition) with a predetermined vertical and horizontal ratio in which an optimal composition can be obtained, in the entire screen as the input replayed image data in this case. Thereafter, when the image part in the optimal composition is specified, the subject detection and composition determination processing block 92 outputs the information representing the position of the image part (trimming instruction information) to the trimming processing block 91.

The trimming processing block 91 executes the image processing for picking up the image part instructed by the trimming instruction information from among the input replayed image data in response to the input of the trimming instruction information, and outputs the picked-up image part as a single piece of independent image data. This is the edited image data.

With such a configuration, as the editing processing of the image data, it is possible to automatically execute the trimming for newly obtaining the image data of a part in the optimal composition picked up from the image content of the original image data.

Such an editing function can be employed for an application for editing the image data to be installed in the personal computer and the like, or as an image editing function in the application to manage the image data.

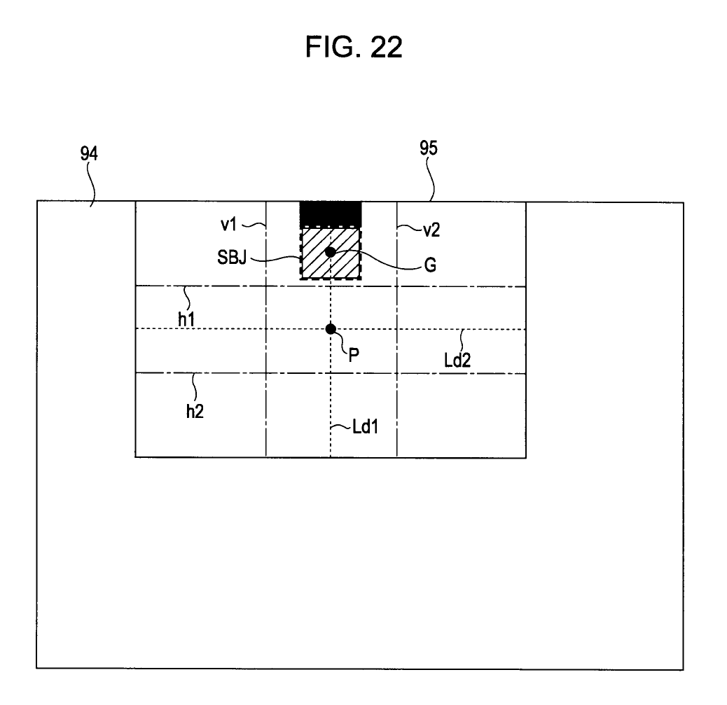

In addition, it is assumed that the image of the replayed image data input by the editing device 90 is the one shown in FIG. 22. In the same drawing, the image of the replayed image data is shown as the replayed image 94. It is also assumed that the subject SBJ exists at the upper end in the image frame in the replayed image 94 as shown in the drawing. The subject detection and composition determination processing block 92 detects this subject and determines the optimal composition.

Here, it is assumed that the optimal composition which is determined by the subject detection and the composition determination processing block 92 with respect to the subject SBJ shown in FIG. 22 is the one shown in FIG. 10A.

In this case, however, there is no image area on the upper side of the subject SBJ in the replayed image 94. In this case, the trimming processing is not allowed to be executed as it is for the image content, which is the same as that in the determined composition, shown in FIG. 10A.

In such a case, if the first embodiment as already described is employed, it is possible to execute the trimming processing so as to obtain the image (editing image) 95 of the edited image data shown in the same drawing, FIG. 22.

That is, in this case, the subject detection and composition determination processing block 92 obtains the subject size which is necessary for the determined composition, and decides the size of the trimming frame with which this subject size can be obtained. The size of the trimming frame here means the size of the image frame of the edited image 95.

Thereafter, the subject detection and composition determination processing block 92 decides the position of the trimming frame in the horizontal direction such that the x coordinate of the subject gravity center G is positioned on the x coordinate of the target coordinate. This is just like moving the trimming frame in the horizontal direction on the replayed image 94 such that the x coordinate of the subject gravity center G coincides with the x coordinate of the target coordinate. However, when the trimming frame is moved in the horizontal direction to the position in which a part of the replayed image 94 is out of the sight, this position is determined to be a limitation position, and the movement is stopped at this stage.

In the case of FIG. 22, the subject gravity center G can be moved in the horizontal direction to the x coordinate of the target coordinate without reaching the limitation position.

In addition, the subject detection and composition determination processing block 92 decides the position of the trimming frame in the vertical direction such that the y coordinate of the subject gravity center G is positioned on the y coordinate of the target coordinate in the same manner as described above.

In the example shown in FIG. 22, if the subject gravity center G is tried to be positioned on the y coordinate of the target coordinate, there appears an area which sticks out of the replayed image 94 on the upper side of the trimming frame. In this case, the position of the edited image 95 shown in FIG. 22 is the limitation position in the vertical direction. That is, the limitation position in this case means the position in which the trimming frame (the edited image 95) does not stick out of the replayed image 94 and the any one of the upper, lower, right, and left sides of the edge portions of the trimming frame and the replayed image 94 are overlapped with each other.

In the case of FIG. 22, the determined composition is not obtained in the above-mentioned limitation position of the trimming frame. In this case, however, the trimming processing is executed by the trimming frame at this time according to the first embodiment of the invention.

That is, when determined composition is not obtained as a result of the setting of the trimming frame in the horizontal or the vertical direction because the trimming frame reaches the limitation position in at least one of the horizontal and vertical directions, the composition with the trimming frame which has been obtained by the position decision processing hitherto is assumed to be OK. In this case, it is not necessary to wait for the elapse of the time T from the timing at which the trimming frame reached the limitation position. Then, the trimming instruction information on the basis of the trimming frame is output to the trimming processing block 91. As a result, it is possible to obtain the edited image data with the image content as the edited image 95 shown in FIG. 22.

Although such an editing device 90 may be configured as a single independent device, it may be also configured as a personal computer device which executes the program as the editing device 90.

The description was made hitherto with a condition that the subject (independent subject) was a person. However, it is possible to apply the embodiments of the present invention to the case in which the subject is not a person but an animal, for example.

In addition, the image data as the target of the subject detection is not limited to only the one which can be obtained by imaging (the captured image data), and may include the image data with the image content such as a drawing, designed image, and the like as subjects.

The composition (the optimal composition) which is determined according to the embodiments of the invention is not necessarily limited to the composition which is decided by the composition setting method such as a method of parting into three parts, in which the number of the detected independent subjects is also taken into consideration. For example, there is a case in which a user thinks that the composition is interesting or rather better based on the configuration settings even if the composition is not considered to be a good one in general. Accordingly, the composition (the optimal composition) which is determined according to the embodiments of the invention may be arbitrarily set while considering the practicality, the entertaining characteristics, and the like, and is not particularly limited.

Moreover, as already described above, at least a part of the configuration on the basis of this application can be implemented by causing the CPU or the DSP to execute the program.

Such a program may be written and stored in the ROM, for example, at the time of manufacturing, or may be stored in the removable storing medium and then installed (including the updating) from this storing medium in the DSP adaptive nonvolatile storing area or the flash memory 30. In addition, the program may be installed by the control of another host device through a data interface such as the USB, the IEEE 1394, and the like. Moreover, the program may be stored in the storage device in the server on the network. In this case, the digital still camera 1 is configured to have the network function, and download and obtain the program from the server.

The present application contains subject matter related to that disclosed in Japanese Priority Patent Application JP 2009-176577 filed in the Japan Patent Office on Jul. 29, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A control device, comprising:
an operation decision means which inputs the information on image data and a subject detected in an image of the image data and decides the operations to be executed based on the position of the subject in the image in the case of a predetermined limitation position state.

2. The control device according to claim 1, further comprising:
a composition determination means which determines a composition of the image including the subject detected in the image of the image data obtained by imaging; and
wherein the limitation position state is a state in which the movable mechanism unit for changing a field-of-view range of an imaging unit is in a movable limitation position, and
wherein the operation decision means decides the operations to be executed when the subject position within the image of the image data in accordance with the determined composition is not obtained without moving the movable mechanism unit beyond the movable limitation position.

3. The control device according to claim 2,
wherein the operation decision means determines that the subject position in the image in accordance with the determined composition is not obtained without moving the movable mechanism unit beyond the movable limitation position when the subject position in the image in accordance with the determined composition was not obtained until a predetermined time elapsed since the movable mechanism unit reached the movable limitation position as a result of the driving and control with respect to the movable mechanism unit by a subject position control means which drives and controls the movable mechanism unit so as to obtain the subject position within the image in accordance with the determined composition with respect to the movable mechanism unit.

4. The control device according to claim 3,
wherein the operation decision means executes a control for storing captured image data, which has been obtained at that time, in a storing medium when the operation decision means determines that the subject position in the image in accordance with the determined composition is not obtained without moving the movable mechanism unit beyond the movable limitation position.

5. The control device according to claim 3,
wherein the operation decision means further includes a field-of-view range changing control means which drives and controls the movable mechanism unit such that a subject which is different from an already detected subject exists in the image of the image data when the operation decision means determines that the subject position in the image in accordance with the determined composition is not obtained without moving the movable mechanism unit beyond the movable limitation position.

6. The control device according to claim 4 or 5,
wherein the operation decision means executes the control for storing the captured image data which has been obtained at that time in the storing medium when the subject position in the image in accordance with the determined composition can be obtained.

7. The control device according to claim 5,
wherein the operation decision means executes the control for storing the captured image data which has been obtained at that time in the storing medium when the subject position in the image in accordance with the determined composition can be obtained.

8. The control device according to claim 6,
wherein when the movable mechanism unit is in the movable limitation position, the operation decision means sets an enlarged margin with respect to a target position which is to be employed as the subject position in the image in accordance with the determined composition, and determines whether or not the subject position in the image in accordance with the determined composition has been obtained based on whether or not the subject is included in the target position to which this enlarged margin is set.

9. The control device according to claim 2,
wherein when the movable mechanism unit is in the movable limitation position, the operation decision means sets an enlarged margin with respect to a target position which is to be employed as the subject position in the image in accordance with the determined composition, and determines whether or not the subject position in the image in accordance with the determined composition has been obtained based on whether or not the subject is included in the target position to which this enlarged margin is set.

10. The control device according to claim 2,
wherein when the position with respect to this control device, which is represented by subject position information as the information on the detected subject, is the position in which the subject position in the image in accordance with the determined composition is not obtained without moving the movable mechanism unit beyond the movable limitation position, the composition determination means excludes the detected subject from targets of the composition determination.

11. The control device according to claim 1, further comprising:
a composition determination means which determines the composition of the image including the detected subject; and
a trimming frame decision means which decides a position of the trimming frame, which represents the range to be trimmed, in the horizontal and vertical directions from the image of the image data in the image of the image data so as to obtain image content in accordance with the determined composition,
wherein the limitation position state is a state in which the trimming frame does not stick out of the image of the image data, and a part of the edge of the trimming frame is overlapped with a part of the edge of the image frame of the image of the image data, and
wherein when the subject position in the image in accordance with the determined composition is not obtained if the trimming frame does not stick out of the image frame of the image of the image data further more from the limitation position state, the operation decision means executes the trimming with the trimming frame set in accordance with the limitation position state.

12. An operation setting method for an imaging device comprising the steps of:
inputting information on image data and a subject detected in an image in the image data;
deciding operations to be executed based on a subject position in the image in the case of a predetermined limitation position state.

13. A program for causing a control device to execute the steps of:
inputting information on image data and a subject detected in an image in the image data;
deciding operations to be executed based on a subject position in the image in the case of a predetermined limitation position state.

14. A control device, comprising:
An operation decision unit which inputs the information on image data and a subject detected in an image of the image data and decides the operations to be executed based on the position of the subject in the image in the case of a predetermined limitation position state.
